(19) United States
(12) Patent Application Publication
(10) Pub. No.: US 2026/0016940 A1
(43) Pub. Date: Jan. 15, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: KAZUYA OGASAWARA, Kanagawa (JP); KOUTA MURASAWA, Kanagawa (JP); TAKAYUKI YAMADA, Kanagawa (JP); FUMINO MATSUI, Kanagawa (JP); SHINJIRO HORI, Kanagawa (JP)

(21) Appl. No.: 19/257,926

(22) Filed: Jul. 2, 2025

(30) Foreign Application Priority Data
Jul. 9, 2024 (JP) 2024-110259

(51) Int. Cl. G06F 3/04845; G06F 3/0482; G06F 3/04847

(52) U.S. Cl. CPC G06F 3/04845; G06F 3/0482; G06F 3/04847

(57) ABSTRACT

The present disclosure is an information processing apparatus configured to generate data of a creation product, and includes: a reception unit configured receive designation of a target impression from a user, the target impression being an impression that is required to be eventually given by the creation product; and a selection unit configured to select a content to be arranged in the creation product from a content group based on the target impression received by the reception unit, and a first content selected by the selection unit in a case where the reception unit receives designation of a first target impression is different from a second content selected by the selection unit in a case where the reception unit receives designation of a second target impression different from the first target impression.

### BACKGROUND

### Field of the Technology

The present disclosure relates to an information processing apparatus, an information processing method, and a storage medium.

### Description of the Related Art

As a method of creating design data of a poster by using an information processing apparatus such as a PC or a smartphone, there is a method of using a template in which shapes and arrangement of images, characters, graphics, and the like to be arranged in the poster are determined advance. Moreover, Japanese Patent Laid-Open No. 2024-004399 (Patent Literature 1) discloses a program that generates poster data in which images and characters (hereinafter, collectively referred also to as “contents”) are automatically arranged in the case where a user designates an impression (target impression) of a poster and the contents to be arranged in the poster.

### SUMMARY

The present disclosure is an information processing apparatus configured to generate data of a creation product, and includes: a reception unit configured receive designation of a target impression from a user, the target impression being an impression that is required to be eventually given by the creation product; and a selection unit configured to select a content to be arranged in the creation product from a content group based on the target impression received by the reception unit, and a first content selected by the selection unit in a case where the reception unit receives designation of a first target impression is different from a second content selected by the selection unit in a case where the reception unit receives designation of a second target impression different from the first target impression.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a poster generation apparatus;

FIG. 2 is a software block diagram of a poster creation application;

FIG. 3 is a software block diagram of a content selection component;

FIG. 4A is a diagram explaining a skeleton;

FIG. 4B is a diagram illustrating an example of metadata;

FIG. 5 is a diagram explaining color scheme patterns;

FIG. 6 is a diagram illustrating a mode selection screen provided by the poster creation application;

FIG. 7 is a diagram illustrating a generation condition setting screen provided by the poster creation application;

FIG. 8 is a diagram illustrating an image designation screen provided by the poster creation application;

FIG. 9 is a diagram illustrating a preview screen provided by the poster creation application;

FIG. 10 is a flowchart illustrating a poster impression quantification process;

FIG. 11 is a diagram explaining a subjective evaluation of a poster;

FIG. 12A is a flowchart that illustrates a content impression quantification process and that explains an image impression quantification process;

FIG. 12B is a flowchart that illustrates the content impression quantification process and that explains a text impression quantification process;

FIG. 13 is a diagram comparing differences in poster generation results depending on operation modes;

FIG. 14 is a flowchart illustrating an operation mode switching process;

FIG. 15A is a flowchart illustrating a poster generation process in an impression prioritized mode;

FIG. 15B is a flowchart of a condition determination process in S1507;

FIG. 16 is a flowchart illustrating a content selection process;

FIG. 17A is a diagram that explains a skeleton selection method and that illustrates an example of a table in which skeletons and impression are associated with one another;

FIG. 17B is a diagram that explains the skeleton selection method, and is an example of a distance determined in the case where a target impression is “premium feel +1, affinity −1, liveliness −2, and substantial feel +2”;

FIG. 17C illustrate examples of skeletons corresponding to Skeleton 1 to Skeleton 4 in FIG. 17A;

FIG. 18A is a diagram that explains a method of selecting a color scheme pattern and fonts and that illustrates an example of a color scheme pattern impression table;

FIG. 18B is a diagram that explains the method of selecting the color scheme pattern and the fonts and that illustrates an example of a font impression table;

FIG. 19 is a software block diagram explaining a layout component in detail;

FIG. 20 is a flowchart illustrating a layout process;

FIG. 21A is a diagram explaining input of the layout component, and is a table summarizing character information designated in a text designation component and an image designated in an image designation component;

FIG. 21B is a diagram explaining input of the layout component, and is an example of a table illustrating the color scheme patterns obtained from a color scheme pattern selection component;

FIG. 21C is a diagram explaining the input of the layout component, and is an example of a table illustrating the fonts obtained from a font selection component;

FIG. 22A is a diagram that explains an operation of the layout component and that illustrates an example of the skeleton;

FIG. 22B is a diagram that explains the operation of the layout component and that illustrates a state of the skeleton after execution of a color scheme assigning process;

FIG. 22C is a diagram that explains the operation of the layout component and that illustrates an example of the skeleton after a process by a text arranging component 2105;

FIG. 23A is a flowchart illustrating the poster generation process in a content prioritized mode;

FIG. 23B is a flowchart that illustrates the poster generation process in the content prioritized mode and that illustrates a condition determination process performed by a skeleton obtaining component in S1507;

FIG. 24A is a diagram that illustrates a modification example of a UI for setting the target impression and that illustrates an example of setting the target impression with a UI on a radar chart;

FIG. 24B is a diagram that illustrates the modification example of the UI for setting the target impression and that illustrates the radar chart in a state where one of impression factors is set to off;

FIG. 24C is a diagram that illustrates a modification example of the UI for setting the target impression and that illustrates an example of a UI for setting the target impression based on sample poster images instead of words;

FIG. 24D is a diagram illustrating the modification example of the UI for setting the target impression, and is a table illustrating impression values corresponding to the sample poster images of FIG. 24C and final target impression values;

FIG. 25 is a diagram that illustrates a modification example of the UI for setting the target impression;

FIG. 26 is a software block diagram of the poster creation application in a second embodiment;

FIG. 27 is a flowchart illustrating the poster generation process in the impression prioritized mode in the second embodiment;

FIG. 28A is a diagram illustrating a data table that is used by a combination generation component and that is a list of obtained skeletons;

FIG. 28B is a diagram illustrating a data table that is used by the combination generation component and that is a list of obtained fonts;

FIG. 28C is a diagram illustrating a data table that is used by the combination generation component and that is a list of obtained color schemes;

FIG. 28D is a diagram illustrating a data table that is used by the combination generation component and that is a list of obtained image data;

FIG. 28E is a diagram illustrating a data table that is used by the combination generation component and that is a list of title character information;

FIG. 28F is a diagram illustrating a generated combination table;

FIG. 29A is a diagram explaining a processing procedure of the combination generation component, and is a table in which a value of a distance between the target impression and a poster estimated impression is associated with each of combinations in the combination table illustrated in FIG. 28F;

FIG. 29B is a diagram explaining the processing procedure of the combination generation component, and is a newly-generated combination table;

FIG. 30 is a software block diagram of the poster creation application in a third embodiment;

FIG. 31 is a diagram illustrating a content designation screen provided by the poster creation application;

FIG. 32 is a flowchart illustrating the poster generation process in the third embodiment;

FIG. 33 is a flowchart illustrating the content selection process in the third embodiment;

FIG. 34 is a software block diagram of the poster creation application in a fourth embodiment;

FIG. 35A a diagram illustrating a generation condition setting screen provided by the poster creation application;

FIG. 35B is a diagram illustrating a content setting screen provided by the poster creation application;

FIG. 36 is a flowchart illustrating the poster generation process in the fourth embodiment;

FIG. 37 is a software block diagram explaining a content extraction component in detail;

FIG. 38A is a flowchart illustrating a content extraction process executed in the case where a user designates an image; and

FIG. 38B is a flowchart illustrating the content extraction process executed in the case where a title is inputted.

### DESCRIPTION OF THE EMBODIMENTS

In Patent Literature 1, the user can freely designate the target impression of the poster and the contents to be used in the poster. Accordingly, it is difficult for a user with a poor design skill to determine how the designation is to be performed to obtain an intended design. Moreover, the user needs to have a clear idea of the contents desired to be used in advance.

Embodiments of the present disclosure are explained below in detail with reference to the attached drawings. Note that the following embodiments do not limit the scope of claims, and not all of combinations of features explained in the present embodiments are necessarily essential for the present disclosure. Note that identical components are denoted by identical reference numerals, and explanation thereof is omitted.

### First Embodiment

In each of the embodiments illustrated below, explanation is given by using, as an example, a method in which an application for poster creation is operated in a poster generation apparatus to generate automatically-designed poster data. In a conventional poster creation application, an environment is such that a user can freely designate a target impression of a poster and contents to be arranged in the poster. Accordingly, the user needs to designate the contents also in the case where contents desired to be used are unclear. In the case where a content not matching the designated target impression is designated in such a situation, the poster generated by the poster creation application is also outputted as a result not matching the target impression. Thus, the user needs to seek out a poster of an intended design by repeatedly designating the content until the poster of the intended design is obtained. In view of this, a poster creation application of a first embodiment selects a content suiting a target impression designated by the user, from a content group. This facilitates generation of a poster in which the content suiting the target impression is arranged.

Note that, in the following explanation, “image” includes a still image and a frame image cut out from a video unless otherwise noted. Moreover, although explanation is given by using a poster as an example of a creation product in the following embodiments, the creation product is not limited to a poster. The embodiments can be used for any creation product that includes at least one of an image content and a text content such as a flyer, a menu, a banner, a calendar, a photocollage, a commendation, a security, a business card, a shop card, a post card, an invitation, a membership card, and the like. Moreover, these creation products may be used by being printed as well as used as electronic contents in a web site, an SNS, a virtual space, and the like.

### <System Configuration>

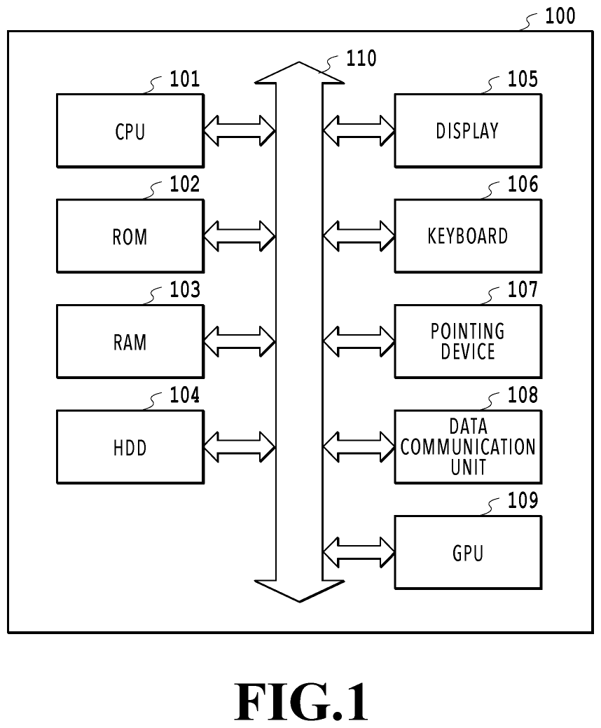

FIG. 1 is a block diagram illustrating a hardware configuration of the poster generation apparatus. Note that the poster generation apparatus 100 is an information processing apparatus, and a personal computer (hereinafter, referred to as PC), a smartphone, or the like can be given as an example. In the present embodiment, explanation is given assuming that the poster generation apparatus is a PC. The poster generation apparatus 100 includes a CPU 101, a ROM 102, a RAM 103, an HDD 104, a display 105, a keyboard 106, a pointing device 107, a data communication unit 108, and a GPU 109.

The CPU (central processing unit/processor) 101 integrally controls the poster generation apparatus 100, and implements operations of the present embodiment by, for example, reading out programs stored in the ROM 102 to the RAM 103 and executing the programs. Although there is one CPU in FIG. 1, multiple CPUs may be provided.

The ROM 102 is a general-purpose ROM, and, for example, programs to be executed by the CPU 101 are stored in the ROM 102. The RAM 103 is a general-purpose RAM, and is used as, for example, a working memory for temporarily storing various pieces of information in execution of the programs by the CPU 101.

The HDD (hard disk) 104 is a storage medium (storage unit) for storing an image file, a database holding processing results of image analysis and the like, a skeleton to be used by the poster creation application, and the like.

The display 105 is a display unit that displays a user interface (UI) of the present embodiment and displays an electronic poster as a layout result of image data (hereinafter, also referred to as “image”) to the user. The keyboard 106 and the pointing device 107 receive instruction operations from the user. The display 105 may have a touch sensor function.

For example, the keyboard 106 is used by the user to input the number of spreads of posters desired to be created on the UI displayed on the display 105.

For example, the pointing device 107 is used by the user to click a button on the UI displayed on the display 105.

The data communication unit 108 communicates with an external apparatus via a wired network, a wireless network, or the like. For example, the data communication unit 108 transmits data subjected to layout by an automatic layout function, to a printer or a server capable of communicating with the poster generation apparatus 100.

The GPU 109 is a processor that performs an image process by receiving a command from the CPU 101. For example, the GPU 109 generates a poster image by analyzing images to be arranged in the poster, estimating impressions of images or texts, estimating an impression of the poster, and executing color scheme assignment and layout of images, texts, and the like on a skeleton.

A data bus 110 communicably connects the blocks of FIG. 1 to one another. Note that the configuration illustrated in FIG. 1 is merely an example, and the present disclosure is not limited to this. For example, the poster generation apparatus 100 may include no display 105, and display the UI on an external display.

The poster creation application in the present embodiment is saved in the HDD 104. The poster creation application is activated in the case where the user executes an operation such as a click or a double click on an icon of the application displayed on the display 105 with the pointing device 107.

### <Software Block Diagram>

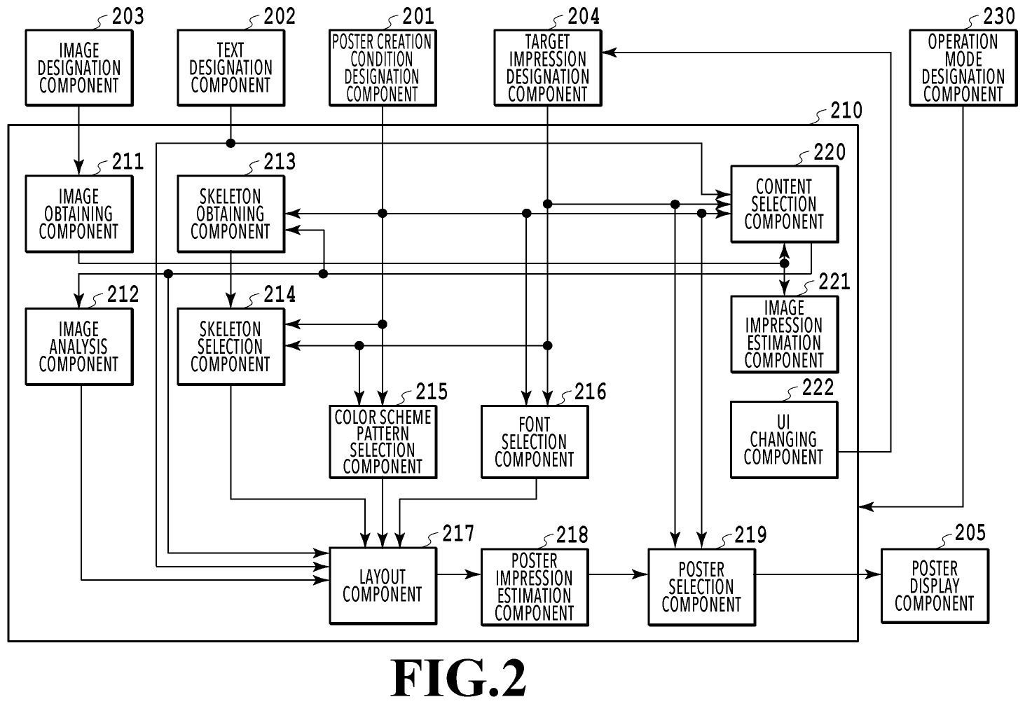

FIG. 2 is an example of a software block diagram of the poster creation application. The poster creation application includes a poster creation condition designation component 201, a text designation component 202, an image designation component 203, a target impression designation component 204, a poster display component 205, a poster generation component 210, and an operation mode designation component 230. The poster generation component 210 includes an image obtaining component 211, an image analysis component 212, a skeleton obtaining component 213, a skeleton selection component 214, a color scheme pattern selection component 215, a font selection component 216, a layout component 217, a poster impression estimation component 218, a poster selection component 219, a content selection component 220, an image impression estimation component 221, and an UI changing component 222. Moreover, FIG. 2 particularly illustrates a software block diagram relating to the poster generation component 210 that executes an automatic poster creation function.

In the case where the poster creation application is installed into the poster generation apparatus 100, an activation icon is displayed on a top screen (desktop) of an operating system (OS) operating on the poster generation apparatus 100, on the display 105. In the case where the activation icon is operated (for example, double-click operation) with the pointing device 107, the program of the poster creation application saved in the HDD 104 is loaded onto the RAM 103, and is executed by the CPU 101. The poster creation application is thereby activated.

Program modules corresponding to the respective components illustrated in FIG. 2 are included in the above-mentioned poster creation application. The CPU 101 executes each of the program modules to function as a corresponding one of the components illustrated in FIG. 2. Hereinafter, as explanation of the components illustrated in FIG. 2, the components are explained to execute various processes.

The operation mode designation component 230 designates an operation mode depending on a UI operation with the pointing device 107. In the present embodiment, there are two operation modes of an impression prioritized mode and a content prioritized mode. Details of each operation mode are described later. The operation mode designation component 230 outputs the designated operation mode to the poster generation component 210.

The poster creation condition designation component 201 designates poster creation conditions depending on a UI operation with the pointing device 107, for the poster generation component 210. In the present embodiment, the size, a creation number, an image number, and a use application category of the poster are designated as the poster creation conditions. Actual dimensional values of width and height or a sheet size such as A1 or A2 may be designated as the size of the poster. The image number is the number of images to be arranged in the poster. The use application category is a category indicating a use application in which the poster is to be used, and is, for example, restaurant, school event, sale, awareness building, and the like. The creation conditions designated in the poster creation condition designation component 201 are inputted into the skeleton obtaining component 213, the skeleton selection component 214, the color scheme pattern selection component 215, the font selection component 216, the poster selection component 219, and the content selection component 220.

The text designation component 202 receives designation of one or multiple pieces of character information that are candidates of character information to be arranged in the poster, the designation performed by the user by performing a UI operation with the keyboard 106. The character information to be arranged on the poster represents, for example, character strings representing a title, time, date, location, and the like. Moreover, the text designation component 202 associates each piece of character information with information (tag or attribute information) indicating the type of the character information such as information indicating whether the character information is information indicating a title or information indicating time, date, and location, and then outputs the candidates of character information to the content selection component 220.

The image designation component 203 receives designation, by the user, of one or multiple pieces of image data (hereinafter, also referred to as image group) that are candidates of image to be arranged in the poster. For example, in the case of image data saved in the HDD 104, designation of the image group is performed based on a structure of a file system including the image data such as a device or a directory. Moreover, designation of the image group based on attribute information or additional information for identifying an image such as shooting date/time may also be performed. Furthermore, the image designation component 203 may designate image data (hereinafter, also referred to as “application material image”) included in the poster creation application and provided as a material, as the image group. Moreover, the image designation component 203 may designate image data (hereinafter, also referred to as “cooperation material image”) included in an external image providing service cooperating with the poster creation application, as the image group. Furthermore, the image designation component 203 may designate image data generated by an image generative AI, as the image group. A generative AI is a machine learning model that generates new data based on trained data, and the image generative AI is a generative AI that generates an image. Specifically, the image generative AI is an AI that can generate an image from a text or an image by using a diffusion model, a GAN model, or the like. The image designation component 203 outputs a file path of the designated image group to the image obtaining component 211.

The target impression designation component 204 receives designation, by the user, of the target impression of the poster to be created. The target impression is an impression that is required to be eventually given by the poster to be created and that is set to be given to a person viewing the created poster (creation product). In the present embodiment, for each of words representing the impression, a UI operation with the pointing device 107 is performed to designate an intensity indicating how much the poster is to give the impression. Information indicating the target impression designated in the target impression designation component 204 is shared with the content selection component 220, the skeleton selection component 214, the color scheme pattern selection component 215, the font selection component 216, and the poster selection component 219. Details of impressions are described later.

The poster generation component 210 executes a poster generation process depending on the operation mode designated in the operation mode designation component 230. The operation mode is described later.

Next, a software configuration of the poster generation component 210 is explained in detail.

The image obtaining component 211 obtains the image group designated by the user in the image designation component 203, from the designated obtaining destination. The image obtaining component 211 outputs the image data included in the obtained image group to the content selection component 220 and the image impression estimation component 221. The obtaining destination of the images includes the HDD 104, a storage region on the network, a PC in which the image generative AI is operating, and the like. Moreover, the obtained images include still images, frame images cut out from a video, material images created in advance for the present application (hereinafter, referred to as application material images), material images provided by an image providing service (hereinafter referred to as cooperation material image), images generated by a generative AI, and the like. The still images and the frame images are images obtained from an imaging device such as a digital camera or a smart device. The imaging device may be included in the poster generation apparatus 100 or an external apparatus. Note that, in the case where the imaging device is the external device, the images are obtained via the data communication unit 108. Moreover, as another example, the still images may be illustration images created with image editing software or CG images created with CG creating software. The still images and cut-out images may be images obtained from a network or a server via the data communication unit 108. The images obtained from the network or the server include social networking service images (hereinafter, referred to as “SNS images”), the cooperation material images, and the images generated by using an image generative AI provided outside the poster generation apparatus 100. Moreover, a program executed by the CPU 101 analyzes data attached to each image and determines a saving source for the image. For example, the obtaining destination of the SNS images may be managed in an application by obtaining the images from an SNS via the application. Note that the images are not limited to the images described above, and may be other types of images.

The content selection component 220 obtains the image number from the poster creation condition designation component 201, the one or multiple candidates of character information from the text designation component 202, the image data included in the image group from the image obtaining component 211, and the designated target impression from the target impression designation component 204. The content selection component 220 selects the image data to be used in the poster from the image data included in the image group, based on the target impression and the image number. Moreover, the content selection component 220 selects the character information to be used in the poster from the character information that are candidates, based on the target impression. In the present embodiment, the content selection component 220 is assumed to select the character information to be set as a title. The content selection component 220 outputs the selected image data to the image analysis component 212 or the layout component 217, and outputs the selected character information to the skeleton obtaining component 213 and the layout component 217.

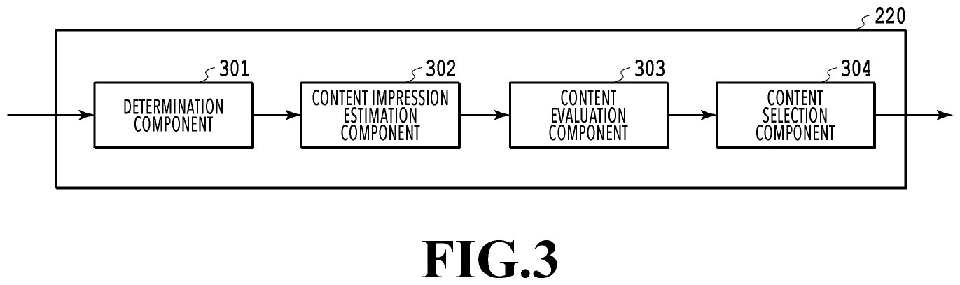

FIG. 3 is a software block diagram of the content selection component 220. As illustrated in FIG. 3, the content selection component 220 includes a determination component 301, a content impression estimation component 302, a content evaluation component 303, and a content selection component 304.

The determination component 301 determines the number of contents to be used in the poster that is designated by the user. In the case where the content is a text, the determination component 301 determines whether or not there are multiple pieces of character information associated with the title among the pieces of character information obtained from the text designation component 202. In the case where there are multiple pieces of character information associated with the title, the determination component 301 outputs the obtained character information associated with the title, to the content impression estimation component 302. Meanwhile, in the case where the content is an image, the determination component 301 determines whether or not the image number designated in the poster creation condition designation component 201 is 0. In the case where the image number is not 0, the determination component 301 further determines whether or not the number of pieces of image data obtained by the image obtaining component 211 is larger than the image number designated in the poster creation condition designation component 201. In the case where the number of pieces of image data obtained in the image obtaining component 211 is larger than the image number, the determination component 301 outputs the image data obtained by the image obtaining component 211, to the content impression estimation component 302.

The content impression estimation component 302 estimates the impressions of multiple contents. The estimation of the impressions of the contents is described later.

The content evaluation component 303 determines a distance between the target impression designated by the user and each of the impressions of the contents estimated by the content impression estimation component 302. In the present embodiment, a Euclidean distance is used as the distance (hereinafter, mere distance means Euclidean distance). The smaller the value indicated by the Euclidean distance is, the closer the impression of the content is to the target impression.

The content selection component 304 selects top N contents in ascending order of the value indicating the distance determined by the content evaluation component 303, for each of the title and the image. In the present embodiment, the content selection component 304 selects top one title and the pieces of image data as many as the image number designated in the poster creation condition designation component 201, in ascending order of the distance. In this case, the selection number N may be a fixed value, or may be variable depending on the conditions designated in the poster creation condition designation component 201. Moreover, the selection number of the image may be a number exceeding the image number designated in the poster creation condition designation component 201. Note that, in the case where the minimum value of the distance determined by the content evaluation component 303 is larger than a predetermined threshold, the content selection component 304 may display a warning screen indicating that a candidate of content giving an impression close to the target impression is absent, on the display 105.

Returning to the explanation of FIG. 2, the image analysis component 212 executes an image data analysis process on the one or multiple pieces of image data obtained from the content selection component 220, and obtains information indicating image feature amounts. Specifically, the image analysis component 212 executes an object recognition process to be described later, and obtains the information indicating the image feature amounts of the image data. Moreover, the image analysis component 212 associates the obtained information indicating the image feature amounts with the image data, and outputs the image data to the layout component 217.

The skeleton obtaining component 213 obtains one or multiple skeletons matching the conditions designated in the poster creation condition designation component 201 and the content selection component 220, from the HDD 104. In the present embodiment, skeletons are each information indicating arrangement of contents (character strings and images), graphics, and the like to be arranged in the poster.

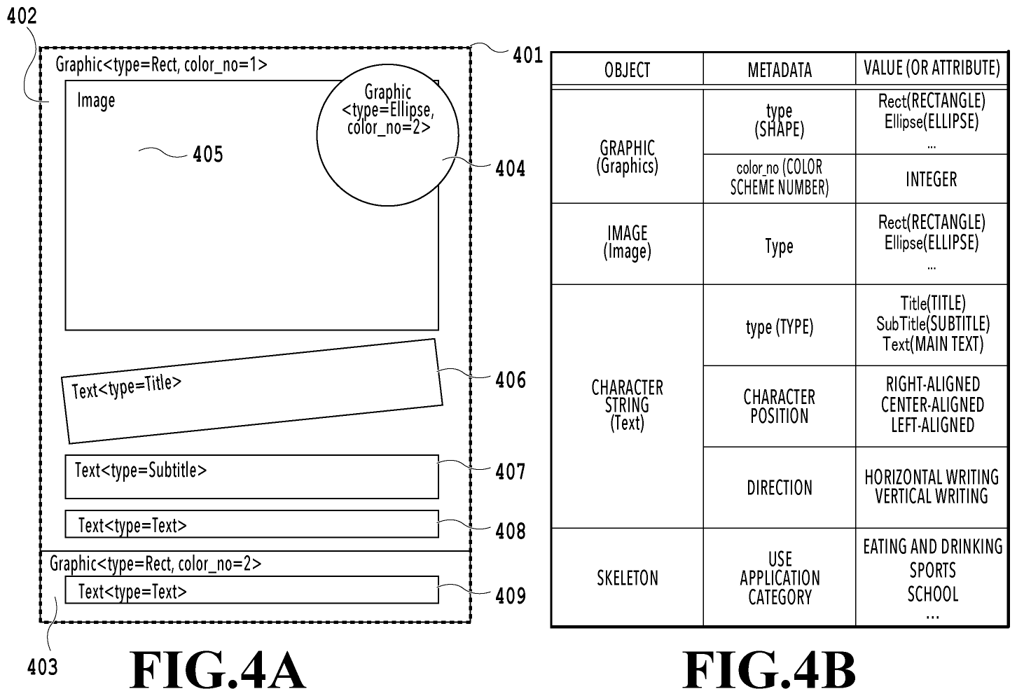

FIGS. 4A and 4B are diagrams illustrating an example of the skeleton. Three graphical objects 402, 403, and 404, one image object 405, and four text objects 406, 407, 408, and 409 that are objects in which characters are to be arranged are arranged on a skeleton 401 of FIG. 4A. In each object, a position indicating a location where the object is arranged, the size and angle of the object, and metadata necessary for generation of the poster are recorded. FIG. 4B is a diagram illustrating an example of the metadata. For example, which type of character information is to be arranged is held in each of the text objects 406 to 409 as an attribute of the metadata. In this example, it is illustrated that a title is to be arranged in the text object 406, a subtitle is to be arranged in the text object 407, and main texts are to be arranged in the text objects 408 and 409. Moreover, a shape of a graphic and a color scheme number (color scheme ID) indicating a color scheme pattern are held in each of the graphical objects 402 to 404 as the attribute of the metadata. In this example, it is illustrated that the attributes of the graphical objects 402 and 403 are rectangle and the attribute of the graphical object 404 is ellipse. Moreover, a color scheme number 1 is assumed to be assigned to the graphical object 402, and a color scheme number 2 is assumed to be assigned to the graphical objects 403 and 404. In this example, it is illustrated that the color scheme number is information referred to in color scheme application to be described later, and different colors are assigned to different color scheme numbers. Note that the types of objects and the metadata are not limited to those described above. For example, a map object for arranging a map or a barcode object for arranging a QR code (registered trademark) or a barcode may be provided. Moreover, metadata indicating a space between lines and a space between characters may be provided as the metadata of the text object. The configuration may be such that the metadata includes a use application of the skeleton, and the use application is used for control of allowing or not allowing use of the skeleton depending on use application.

For example, the skeleton may be saved in the HDD 104 in a CSV format or in a DB format such as SQL. The skeleton obtaining component 213 outputs the one or multiple skeletons obtained from the HDD 104, to the skeleton selection component 214.

The skeleton selection component 214 selects one or multiple skeletons matching the target impression designated in the target impression designation component 204 among the skeletons obtained from the skeleton obtaining component 213, and outputs the selected skeleton to the layout component 217. Since the arrangement of the entire poster is determined by the skeleton, preparing various types of skeletons in advance can increase variety of generated posters.

The color scheme pattern selection component 215 obtains one or multiple color scheme patterns matching the target impression designated in the target impression designation component 204, from the HDD 104, and outputs the obtained color scheme patterns to the layout component 217. The color scheme patterns are each a combination of colors to be used in the poster.

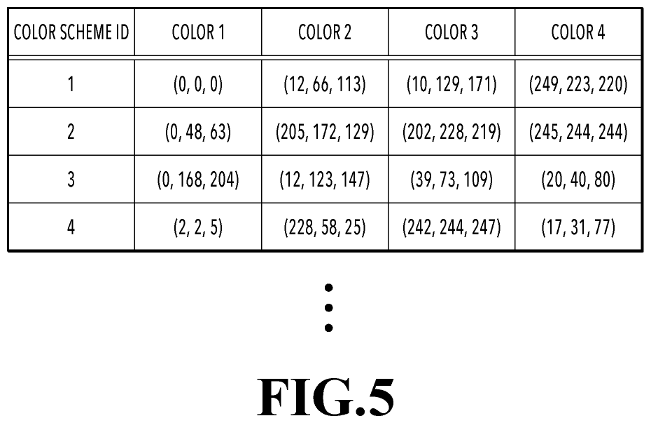

FIG. 5 is a diagram illustrating an example of a table of the color scheme patterns. In the present embodiment, each color scheme pattern is illustrated as a combination of four colors. The column of color scheme ID in FIG. 5 is an ID for uniquely identifying the color scheme pattern. Columns of color 1 to color 4 each illustrate a color value of each of R, G, and B in a value of 0 to 255 in the order of RGB ((R, G, B)=(0 to 255, 0 to 255, 0 to 255)). Although the color scheme pattern formed of the combination of four colors is used in the present embodiment, the number of colors may be another number, or multiple numbers of colors may coexist.

The font selection component 216 selects one or multiple font patterns matching the target impression designated in the target impression designation component 204, obtains the selected font patterns from the HDD 104, and outputs the font patterns to the layout component 217. The font patterns are each a combination of at least one of a font of the title, a font of the subtitle, and a font of the main text.

The layout component 217 lays out various contents on each of the one or multiple skeletons obtained from the skeleton selection component 214, and thereby generates one or multiple pieces of poster data as many as or more than the designated poster creation number. The layout component 217 arranges the text (title) selected by the content selection component 220, the text (other than the title) obtained from the text designation component 202, and the image data obtained from the image analysis component 212 or the content selection component 220, on each skeleton. Moreover, the layout component 217 applies each color scheme pattern obtained from the color scheme pattern selection component 215, and applies each font pattern obtained from the font selection component. The layout component 217 outputs the generated one or multiple pieces of poster data to the poster impression estimation component 218.

The poster impression estimation component 218 estimates the impression of each of the multiple pieces of poster data obtained from the layout component 217, and associates the estimated impression with the piece of poster data. Then, the poster impression estimation component 218 outputs the one or multiple pieces of poster data associated with the estimated impression, to the poster selection component 219.

The poster selection component 219 compares the target impression designated in the target impression designation component 204 and each of the estimated impressions of the multiple pieces of poster data associated with the estimated impressions obtained from the poster impression estimation component 218, and selects the poster data associated with the estimated impression close to the target impression. The poster selection component 219 selects posters as many as or more than the creation number designated in the poster creation condition designation component 201. In this case, the poster selection component 219 selects posters as many as or more than the creation number, in ascending order of a value (for example, Euclidean distance) indicating a difference between the target impression and the estimated impression. The closeness between the target impression and the estimated impression is determined based on a difference of an impression value for each impression factor. The selection result is saved in the HDD 104. The poster selection component 219 outputs the selected poster data to the poster display component 205.

The poster display component 205 displays poster images based on the poster data obtained from the poster selection component 219, on the display 105. The poster images are, for example, bit map data. Note that, since the pieces of poster data as many as or more than the creation number designated in the poster creation condition designation component 201 are generated in the poster generation component 210, previews of the poster images are displayed on the display 105 as a list. In the case where the user clicks any of the poster images with the pointing device 107, the clicked poster image is set to a selected state.

Note that the poster creation application may be additionally provided with a function of further changing each poster to a design desired by the user after the display of the generation result in the poster display component 205 by editing the arrangement, the colors, the shapes, and the like of the image, the text, and the graphic by additional user operations (not illustrated). Moreover, providing a function of printing the poster data saved in the HDD 104 with a printer under a condition designated in the poster creation condition designation component 201 allows the user to obtain a print product of the created poster.

The image impression estimation component 221 and the UI changing component 222 are software blocks used in the content prioritized mode to be described later. The image impression estimation component 221 estimates the impression of the image data obtained from the image obtaining component 211, and outputs the estimated impression to the UI changing component 222.

The UI changing component 222 determines information for changing the UI for setting the target impression and setting conditions of the target impression, based on the impression of the image data obtained from the image impression estimation component 221, and outputs the information to the target impression designation component 204. In the content prioritized mode, the target impression designation component 204 changes operable ranges of the target impression in a generation condition setting screen 701 and a display form of an operation object (UI), based on the information for changing the UI and the setting conditions of the target impression obtained from the UI changing component 222.

### Example of Display Screen

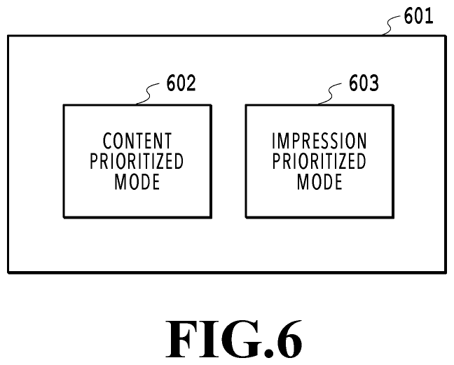

FIG. 6 is a diagram illustrating an example of a mode selection screen 601 provided by the poster creation application. The mode selection screen 601 is displayed on the display 105. The user sets the operation mode to be described later through the mode selection screen 601.

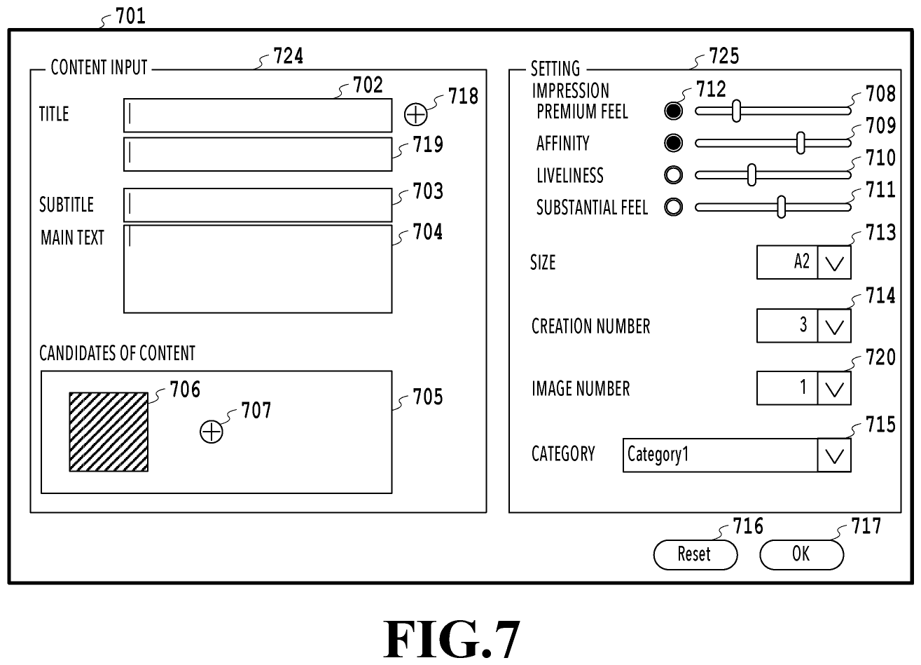

A content prioritized mode button 602 of the mode selection screen 601 is a button for setting the operation mode in the poster creation application to the content prioritized mode. In the case where the content prioritized mode button 602 is pressed, the generation condition setting screen 701 illustrated in FIG. 7 is displayed on the display 105. Note that, in the case where the user designates a content (for example, image data) to be arranged in the poster, in the generation condition setting screen 701 displayed in the content prioritized mode, the UI for setting the target impression is displayed with a display state of the UI changed based on the impression of the designated image data. Details of the content prioritized mode are described later.

An impression prioritized mode button 603 of the mode selection screen 601 is a button for setting the operation mode in the poster creation application to the impression prioritized mode. In the case where the impression prioritized mode button 603 is pressed, the generation condition setting screen 701 illustrated in FIG. 7 is displayed on the display 105.

FIG. 7 is a diagram illustrating an example of the generation condition setting screen 701 provided by the poster creation application. The generation condition setting screen 701 is displayed on the display 105. The user designates a text and an image that are the contents to be arranged on the poster, the target impression of the poster to be created, and the creating conditions (size, creation number, image number, and use application category) of the poster, through the generation condition setting screen 701. The poster creation condition designation component 201, the image designation component 203, and the text designation component 202 obtain contents of the designation from the user through this UI screen.

The generation condition setting screen 701 is provided with a content input region 724 and a condition setting region 725.

A title box 702, a subtitle box 703, and a main text box 704 in the content input region 724 receive designation, by the user, of the character information to be arranged in the poster. Note that, although three types of character information are received in the present embodiment, the present disclosure is not limited to this. For example, character information such as location, time, and date may also be additionally received. Moreover, the character information does not have to be inputted into all boxes, and there may be a blank box.

A title addition button 718 is a button operated in the case where an additional title box 719 is to be displayed. For example, in the case where there are multiple candidates of title character information and the user desires to designate multiple pieces of title character information, the title addition button 718 is operated. Note that the title addition button 718 is set to an unpressable state in the content prioritized mode.

The additional title box 719 receives designation of the character information like the title box 702. The user can designate multiple pieces of character information as the candidates of title by designating the character information in the title box 702 and the title box 719. Note that, although designation of multiple pieces of character information is received only for the title in the present embodiment, the present disclosure is not limited to this. An addition button and an additional box for each of the subtitle and the main text may also be provided to receive designation of multiple pieces of character information. Note that the method of designating multiple pieces of character information is not limited to the above method. For example, the configuration may be such that the text designation component 202 divides the character information designated by the user in the title box 702 at a line feed character, and multiple pieces of divided character information are designated as multiple candidates of title.

An image designation region 705 in the content input region 724 is a region in which an image to be arranged in the poster is designated. An image 706 illustrates a thumbnail of the image designated by the user or selected by the content selection component 220. An image addition button 707 is a button for adding the image to be arranged in the poster. In the case where the user presses the image addition button 707, the image designation component 203 displays an image designation screen 801 for selecting an image file, and receives designation of the image group by the user. In the case where the image group is designated, the content selection component 220 selects one or multiple images from the image group. Thumbnails of the images selected by the content selection component 220 are displayed in the image designation region 705.

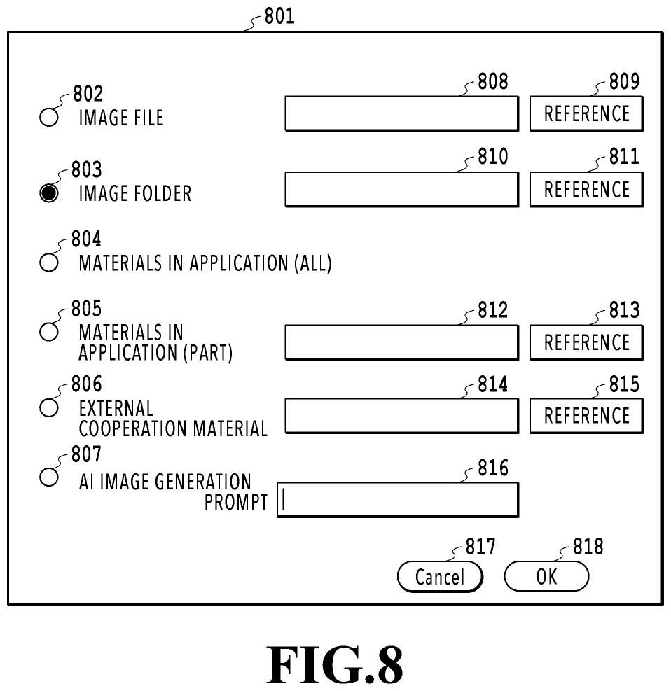

The image designation screen 801 is explained by using FIG. 8. The image designation screen 801 is displayed on the display 105. The user can designate the image to be arranged in the poster or an obtaining destination of the image group including multiple images, through the image designation screen 801. The image designation component 203 obtains setting contents from the user through this UI screen.

Radio buttons 802 to 807 are each a button for setting a method of designating the image group or the image data to be the candidate. The user can press the radio buttons 802 to 807 to set on/off of the methods of designating the image data. Although multiple radio buttons are displayed, only one radio button can be set to on. Specifically, in the case where a radio button set to off is set to on, this radio button is set to an on state, but a radio button in the on state before the setting is automatically set to off.

The radio button 802 is a button for setting, as the method of designating the image, a method in which one or multiple pieces of image data is designated. A designation box 808 receives designation of the one or multiple pieces of image data. The user can designate each piece of image data to be a candidate by designating a file path of the image data in the designation box 808. A reference button 809 is a button for designating the one or multiple pieces of image data. In the case where the user presses the reference button 809, the image designation component 203 displays a dialog screen for selecting a file saved in the HDD 104, and receives image file selection by the user.

The radio button 803 is a button for setting, as the method of designating the image, a method in which a folder including one or multiple pieces of image data is designated as the obtaining destination of the image group. A designation box 810 receives designation of the folder including one or multiple pieces of image data. The user can designate all pieces of image data included in the folder as the image group by designating a folder path in the designation box 810. A reference button 811 is a button for designating the obtaining destination folder. In the case where the user presses the reference button 811, the image designation component 203 displays a dialog screen for selecting a folder saved in the HDD 104, and receives folder selection by the user.

The radio button 804 is a button for setting, as the method of designating the image, a method in which all application material images are designated. In the case where the radio button 804 is on, all application material images are designated as the candidate images.

The radio button 805 is a button for setting, as the method of designating the image, a method in which some of the application material images are designated. A designation box 812 displays names of the application material images designated through a reference button 813. The reference button 813 is a button for designating one or multiple application material images. In the case where the user presses the reference button 813, the image designation component 203 displays a dialog screen for selecting the application material images, and receives image selection by the user. Note that, in the case where tag information is given to each application material image, the configuration may be such that the user can designate a tag to select the application material images to which this tag is attached in a batch.

The radio button 806 is a button for setting, as the method of designating the image, a method in which cooperation material images are designated. A designation box 814 displays names of the cooperation material images designated through a reference button 815. The reference button 815 is a button for designating one or multiple cooperation material images. In the case where the user presses the reference button 815, the image designation component 203 displays a dialog screen for selecting the cooperation material images, and receives image selection by the user. Note that, in the case where tag information is given to each cooperation material image, the configuration may be such that the user can designate a tag to select the cooperation material images to which this tag is attached in a batch.

The radio button 807 is a button for setting, as the method of designating the image, a method in which images are generated by using the image generative AI. A prompt box 816 receives designation of a prompt to be used as input of the image generative AI. Then, the image designation component 203 generates images by using the designated prompt and the image generative AI, and saves the generated images in the HDD 104. In the present embodiment, the image data is generated from the prompt by using Stable Diffusion. Then, the image designation component 203 designates the saved AI-generated images.

In the case where the user has clearly determined the image desired to be used in the poster, the user sets one of the radio buttons 802, 805, 806, and 807 to on, and designates the obtaining destinations of the one or multiple images to be used in the poster. Meanwhile, in the case where the user has not clearly determined the image desired to be used in the poster, the use can set the radio button 803 or 804 to on, and designate an entire image folder or all materials in the application as the image group. Moreover, the user may designate one of the radio buttons 802, 805, 806, and 807, and designate multiple image candidates as the image group. In any case, determination of a specific image to be used in the poster by the user is not necessary.

A cancel button 817 is a button for cancelling the designation of the image. In the case where the cancel button 817 is pressed, the pieces of setting information on the image designation screen 801 are ignored, and the screen displayed on the display 105 transitions to the generation condition setting screen 701. In the case where the user presses an OK button 818, the screen displayed on the display 105 transitions to the generation condition setting screen 701. In this case, thumbnails of images selected from the image group designated in the image designation screen 801 in a content selection process to be described later are added to the image designation region 705 of the generation condition setting screen 701.

Explanation returns to FIG. 7. Impression sliders 708 to 711 of the generation condition setting screen 701 are each an operation object (UI) with which the user sets a value indicating a degree of the target impression of the poster to be created for a corresponding one of factors (hereinafter, referred to as impression factors) of the target impression. For example, the impression slider 708 is a slider for setting a value indicating a degree of the target impression for an impression factor “premium feel”. The target impression is set such that the further the impression slider 708 is slid to the right, the higher the impression of premium feel given by the poster is, and the further the impression slider 708 is slid to the left, the lower (cheaper) the impression of premium feel given by the poster is. Moreover, combining the factors of the target impression set in the respective sliders enables setting of a comprehensive target impression reflecting not only the impression factor set in one slider but also the impression factors set in the other sliders.

For example, in the case where the impression slider 708 corresponding to the impression factor “premium feel” is set on the right side of the center and the impression slider 711 corresponding to an impression factor “substantial feel” is set on the left side of the center, a poster with an elegant impression that has high premium feel and low substantial feel is generated. Moreover, for example, in the case where the impression slider 708 corresponding to the impression factor “premium feel” is set on the right side of the center and the impression slider 711 corresponding to the impression factor “substantial feel” is set on the right side of the center, a poster with a gorgeous impression that has high premium feel and high substantial feel is generated. Combining the factors of target impression indicated by the multiple impression sliders as described above enables setting of target impressions of various directions such as the “elegant” target impression and the “gorgeous” target impression even in the case where the factor “premium feel” of the target impression is commonly set to presence of “premium feel”.

Specifically, the target impression is formed of and determined by multiple factors indicating the impression. Note that the target impression may be determined by one factor indicating the impression. In the present embodiment, each of the values indicating the impression is assumed to be corrected to a value from −2 to +2 with −2 being a state where the slider set to the left-most position and +2 being a state where the slider is set to the right-most position. These numerical values are values indicating that −2 is low, −1 is slightly low, 0 is neither high nor low, +1 is slightly high, and +2 is high for the impression. Note that purpose of correcting the value to a value from −2 to +2 is to match the value with a scale of the estimated impression and facilitate distance calculation to be described later. The present disclosure is not limited to this, and normalization may be performed by using a value from 0 to 1.

Radio buttons 712 are buttons that enable execution of control of enabling or disabling setting of the respective impression factors. The user can set whether to enable or disable the setting of each impression factor by pressing a corresponding one of the radio buttons 712 and setting on/off. For example, in the case where off is selected in one of the radio buttons 712, the corresponding impression factor is excluded from the control of impression. For example, in the case where a calm poster with low liveliness is desired to be created and there is no particular designation for other impressions, the user can set the radio buttons 712 for the impression factors other than the liveliness to off to create a poster specialized in low liveliness. Note that FIG. 7 illustrates a state where premium feel and affinity are set to on, and liveliness and substantial feel are set to off. This enables control with high flexibility in which all impression factors are used for the poster generation or only some of the impression factors are used for the poster generation. Note that, in the case where a state in which each of the sliders is set to the left-most position is considered to be the same as a state in which a corresponding one of the impression factors is not set, a configuration provided with no radio buttons 712 may be employed. In this case, in the case where the setting of each impression factor is to be disabled, the user can disable the setting of the impression factor by setting the corresponding slider to the left-most position.

A size list box 713 is a list box for setting the size of the poster to be created. The user can perform a click operation with the pointing device 107 to display a list of creatable poster sizes and select a poster size. The number of candidates of the poster to be created can be set in a creation number box 714. The number of images to be used in the poster can be set in an image number box 720. The use application category of the poster to be created can be set in a category list box 715.

A reset button 716 is a button for resetting the pieces of setting information on the generation condition setting screen 701.

In the case where the user presses an OK button 717, the poster creation condition designation component 201 and the target impression designation component 204 output the information set on the generation condition setting screen 701, to the poster generation component 210. In this case, the poster creation condition designation component 201 obtains the size of the poster to be created from the size list box 713, and obtains the number of posters to be created from the creation number box 714. Moreover, the poster creation condition designation component 201 obtains the number of images to be used from the image number box 720, and obtains the use application category of the poster to be created from the category list box 715. The text designation component 202 obtains the character information inputted in the title boxes 702 and 719, the subtitle box 703, and the main text box 704. The image designation component 203 obtains the file path of the image to be arranged in the poster from the image designation region 705. The target impression designation component 204 obtains the target impression of the poster to be created from the impression sliders 708 to 711 and the radio buttons 712. Note that the poster creation condition designation component 201, the text designation component 202, the image designation component 203, and the target impression designation component 204 may process the values set in the generation condition setting screen 701. For example, the text designation component 202 may remove unnecessary whitespace characters at a head or an end of the inputted character information, from the character information. Moreover, the target impression designation component 204 may correct the values of the target impression designated in the impression sliders 708 to 711.

In the case where the number of pieces of image data designated in the image designation region 705 is smaller than the number designated in the image number box 720, the poster creation condition designation component 201 displays a dialog screen prompting the user to add images. Alternatively, the poster creation condition designation component 201 may change the number designatable in the image number box 720 depending on the number of pieces of image data designated in the image designation region 705. For example, in the case where the number of pieces of image data designated in the image designation region 705 is two, the poster creation condition designation component 201 may limit the number designatable in the image number box 720 to one of 0, 1, and 2.

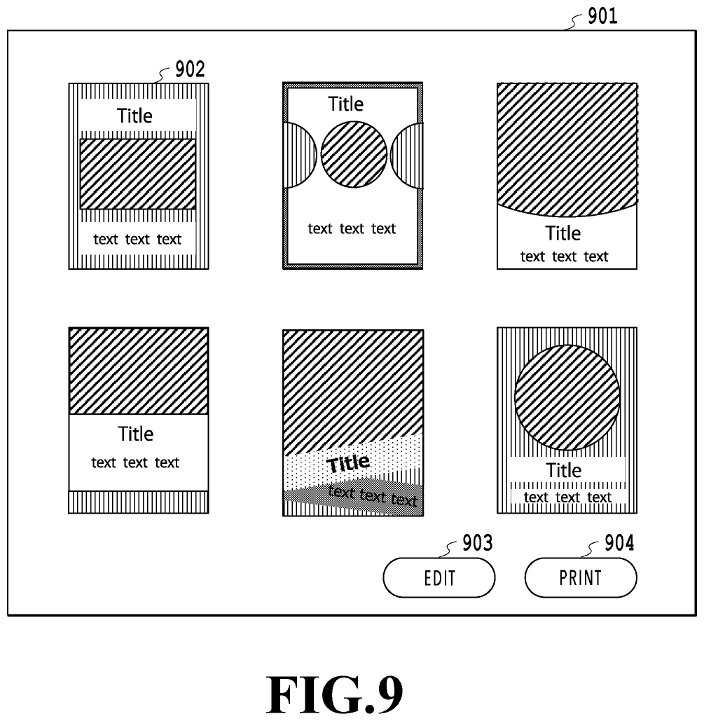

FIG. 9 is a diagram illustrating an example of a poster preview screen 901 in which generated poster images 902 are displayed on the display 105 by the poster generation component 210. In the case where the OK button 717 of the generation condition setting screen 701 is pressed and the poster generation is completed, the screen displayed on the display 105 transitions to the poster preview screen 901.

The poster images 902 are poster images outputted by the poster display component 205. Since the pieces of poster data as many as or more than the creation number designated in the poster creation condition designation component 201 are generated in the poster generation component 210, poster images 902 as many as the number of generated pieces of poster data are displayed as a list. In the case where the user clicks one of the poster images 902 with the pointing device 107, the poster data corresponding to the clicked poster image 902 is set to a selected state.

An edit button 903 is a button for transition to a function of editing the poster data set to the selected state. In the edit function, editing of the poster data can be performed through a not-illustrated UI.

A print button 904 is a button for transition to a function of printing the poster data set to the selected state. In the print function, the poster data can be printed through a not-illustrated control UI of a printer.

### <Poster Impression Quantification>

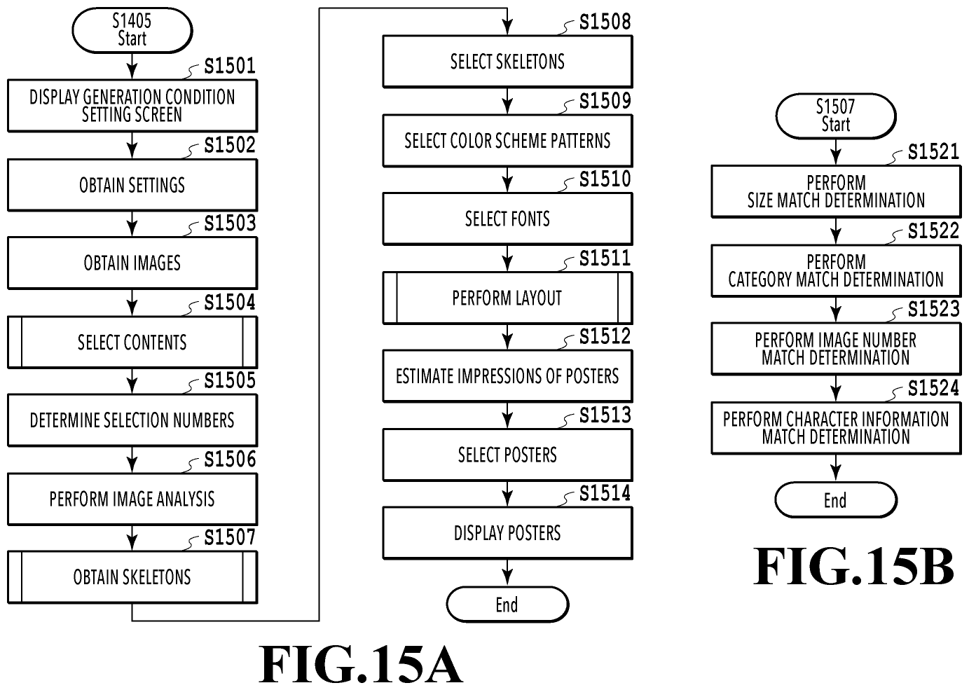

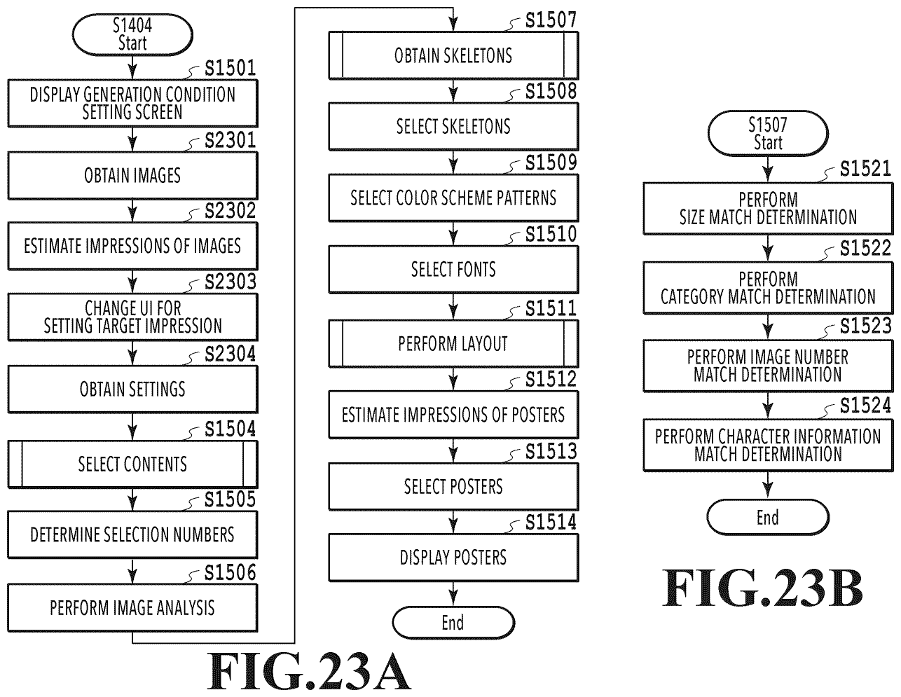

A process (hereinafter, referred to as poster impression quantification process) of quantifying the impression of each poster is explained. The poster impression quantification process is a preliminary process necessary for execution of a poster impression estimation process (S1512 of FIG. 15A) to be described later. The poster impression estimation process is executed in the poster generation process (FIGS. 15A, 15B, 23A, and 23B) to be described later.

The poster impression quantification process is performed in a development stage of the poster creation application by a vendor or the like developing the poster creation application. Note that the poster impression quantification process may be executed in the poster generation apparatus 100 or in an information processing apparatus different from the poster generation apparatus 100. Note that, in the case where the poster impression quantification process is executed in the information processing apparatus different from the poster generation apparatus 100, the poster impression quantification process is executed by a CPU of the information processing apparatus.

In the poster impression quantification process, impressions felt by a person for various posters are quantified. Simultaneously, correspondence relationships between the poster images and the impressions of the posters are derived. This allows the impression of the poster to be estimated from the generated poster image. In the case where the estimation of the impression is possible, it is possible to control the impression of the poster by correcting the poster image or to search for the poster image giving a certain target impression. Note that the poster impression quantification process is executed by, for example, operating an impression learning application for learning the impressions of the poster images in advance in the poster generation apparatus before the poster generation process.

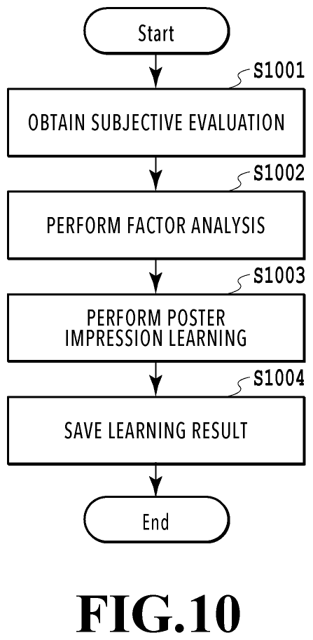

FIG. 10 is a flowchart illustrating the poster impression quantification process. For example, the CPU 101 implements the flowchart illustrated in FIG. 10 by reading out programs stored in the HDD 104 to the RAM 103 and executing the programs. The poster impression quantification process is explained with reference to FIG. 10. Note that sign “S” in explanation of each process means step in the flowchart (the same applies below in the present specification).

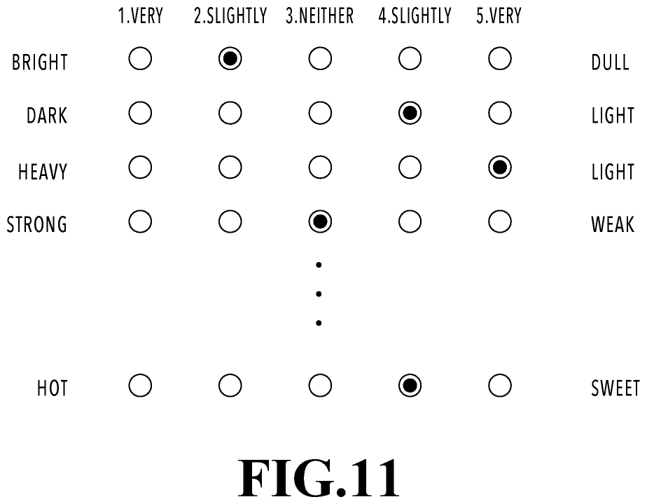

In S1001, the CPU 101 obtains a subjective evaluation of the impression of each poster. FIG. 11 is a diagram explaining an example of a subjective evaluation method of the impression of the poster. The CPU 101 presents the poster to a trial subject, and obtains, from the trial subject, the subjective evaluation of the impression received from the poster. In this case, a measurement method such as a semantic differential (SD) method or a Likert scale method can be used. FIG. 11 illustrates an example of a questionnaire that uses the SD method and in which the pairs of adjectives representing impressions are presented to multiple evaluators and scoring is performed for the pairs of adjectives evoked by the target poster. The CPU 101 obtains subjective evaluation results of multiple posters from the multiple trial subjects, determines an average value of answers for each pair of adjectives, and sets the average value as a representative score of the corresponding pair of adjectives. Note that the subjective evaluation method of the impression may be a method other than the SD method, and it is only necessary that a word expressing the impression and a score corresponding to this word are determined.

In S1002, the CPU 101 executes factor analysis of each of the subjective evaluation results obtained in S1001. In the case where the subjective evaluation result is used as it is, the number of the pairs of adjectives is equal to the number of dimensions, and the control is complex. Accordingly, it is desirable to reduce the number of dimensions to an efficient number of dimensions by using an analysis method such as principal component analysis or factor analysis. In the present embodiment, explanation is given assuming that the dimensions are reduced to four factors by the factor analysis. As a matter of course, this number may change depending on the selection of the pairs of adjectives in the subjective evaluation and the factor analysis method. Moreover, an output of the factor analysis is assumed to be standardized. Specifically, each factor is scaled such that a mean is 0 and a variance is 1 in the poster used in the analysis. This allows −2, −1, 0, +1, and +2 of the impression designated in the target impression designation component 204 to directly correspond to −2σ, −1σ, a mean value, +1σ, and +2σ in each impression, and calculation of the distance between the target impression and the estimated impression to be described later is facilitated. Note that, although the premium feel, affinity, liveliness, and substantial feel illustrated in FIG. 7 are described as the four factors in the present embodiment, these are names given for the sake of convenience to convey the impressions to the user through the user interface, and each factor is formed of multiple pairs of adjectives influencing one another. Moreover, the CPU 101 saves a formula (hereinafter, referred to as “impression conversion formula”) for conversion from the subjective evaluation results of the respective pairs of adjectives obtained by the factor analysis to the values of the respective impressions, in the HDD

In S1003, the CPU 101 associates the poster image and the impression with each other. Although the quantification can be performed on the poster subjected to the subjective evaluation in the above-mentioned method, the estimation of the impression needs to be performed also for a poster to be created from here on without the subjective evaluation. The association of the poster image and the impression can be implemented by training a model that estimates the impression from the poster image. Specifically, for example, a deep learning method using convolution neural network (CNN) or visual transformer (ViT), a machine learning method using a decision tree, or the like can be used. In the present embodiment, the CPU 101 performs supervised deep learning using CNN with the poster image being an input and the four factors being an output. Specifically, the CPU 101 creates a deep learning model by performing training with the poster image subjected to the subjective evaluation and the corresponding impression being correct answers, and inputs an unknown poster image into this learning model to estimate the impression.

In S1004, the CPU 101 saves a model configuration and trained parameters of the deep learning model for impression estimation created in S1003, in the HDD 104.

The poster impression estimation component 218 expands the deep learning model saved in the HDD 104 on the RAM 103, and executes the deep learning model. The poster impression estimation component 218 forms an image of the poster data obtained from the layout component 217, and estimates the impression of the poster by causing the deep learning model expanded on the RAM 103 to operate with the CPU 101 or the GPU 109. Note that, although the deep learning method is used in the present embodiment, the present disclosure is not limited to this. For example, in the case where the machine learning method such as the decision tree is used, there may be created a machine learning model that extracts feature amounts such as a brightness average value, an edge amount, and the like of the poster image by performing image analysis and that estimates the impression based on these feature amounts.

### <Content Impression Quantification>

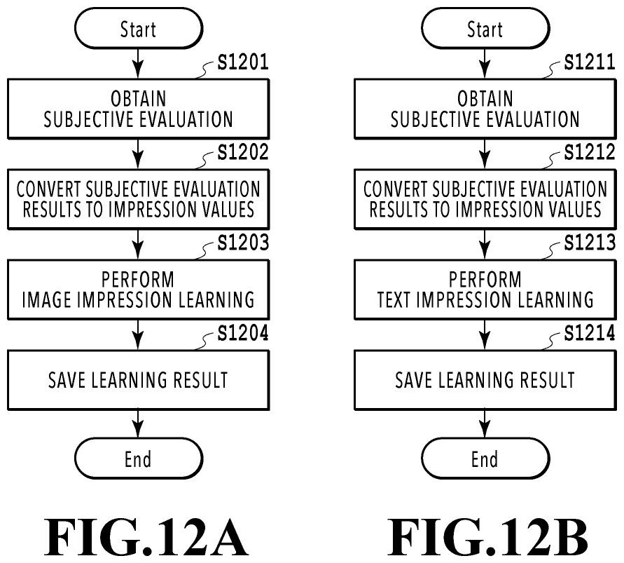

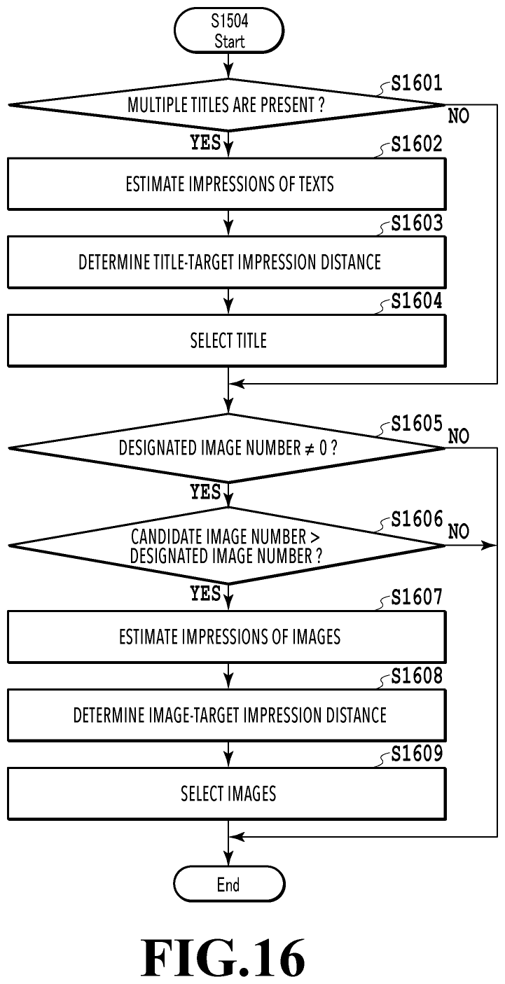

Next, a process (hereinafter, referred to as content impression quantification process) of quantifying the impression of each content is explained with reference to FIGS. 12A and 12B. The content impression quantification process is a preliminary process for executing a text impression estimation process (S1602 of FIG. 16) or an image impression estimation process (S1607 of FIG. 16). The content impression quantification process is performed in a development stage of the poster creation application by the vendor or the like developing the poster creation application. Note that the content impression quantification process may be executed in the poster generation apparatus 100 or in an information processing apparatus different from the poster generation apparatus 100. Note that, in the case where the content impression quantification process is executed in the information processing apparatus different from the poster generation apparatus 100, the content impression quantification process is executed by a CPU of the information processing apparatus.

In the content impression quantification process, there is derived a correspondence relationship between the content itself and the impression of the content in a space in which the impression of the poster is quantified. This enables searching of the content suiting the impression of the poster desired to be generated. Note that the content impression quantification process is executed by, for example, causing an impression learning application for learning the impression of the content to operate in advance in the poster generation apparatus before the poster generation process. Moreover, since the content impression quantification process uses the impression conversion formula obtained in the poster impression quantification process illustrated in FIG. 10, the content impression quantification process needs to be executed after the poster impression quantification process.

FIGS. 12A and 12B are flowcharts illustrating the content impression quantification process. For example, the CPU 101 implements the flowcharts illustrated in FIGS. 12A and 12B by reading out programs stored in the HDD 104 to the RAM 103 and executing the programs. First, the image impression quantification process is explained with reference to FIG. 12A.

In S1201, the CPU 101 obtains a subjective evaluation of the impression of each image. A method similar to the method of the subjective evaluation executed in the poster impression quantification process may be performed for the subjective evaluation. After obtaining subjective evaluation results of multiple images from multiple trial subjects, the CPU 101 determines an average value of answers for each pair of adjectives, and sets the average value as a representative score of the corresponding pair of adjectives. Note that the subjective evaluation method of the impression may be a method other than the SD method, and it is only necessary that a word representing the impression and a score corresponding to this word are determined.

In S1202, the CPU 101 obtains the impression conversion formula obtained in the factor analysis performed in the poster impression quantification process, from the HDD 104, and applies the impression conversion formula to each of the subjective evaluation results obtained in S1201 to obtain impression values of each image. Applying the impression conversion formula obtained in the poster impression quantification process allows the impression of the image to be quantified on dimensions having the same meaning as the impression of the poster.

In S1203, the CPU 101 associates the image and the impression with each other. Although the quantification can be performed on the image subjected to the subjective evaluation in the above-mentioned method, the estimation of the impression needs to be performed also for an unknown image without the subjective evaluation, in the poster generation process of the present embodiment. The association of the image and the impression can be implemented by training a model that estimates the impression from the image. Specifically, for example, a deep learning method using convolution neural network (CNN) or visual transformer (ViT), a machine learning method using a decision tree, or the like can be used. In the present embodiment, the CPU 101 performs supervised deep learning using CNN with the image being an input and the four factors being an output. Specifically, the CPU 101 creates a deep learning model by performing training with the image subjected to the subjective evaluation and the corresponding impression being correct answers, and inputs an unknown image into this learning model to estimate the impression.

In S1204, the CPU 101 saves a model configuration and trained parameters of the deep learning model for impression estimation created in S1203, in the HDD 104.

Next, a text impression quantification process is explained with reference to FIG. 12B.

In S1211, the CPU 101 obtains a subjective evaluation of the impression of each text. A method similar to the method of the subjective evaluation executed in the poster impression quantification process may be performed for the subjective evaluation. After obtaining subjective evaluation results of multiple texts from multiple trial subjects, the CPU 101 determines an average value of answers for each pair of adjectives, and sets the average value as a representative score of the corresponding pair of adjectives. Note that the subjective evaluation method of the impression may be a method other than the SD method, and it is only necessary that a word representing the impression and a score corresponding to this word are determined.

In S1212, the CPU 101 obtains the impression conversion formula obtained in the factor analysis performed in the poster impression quantification process, from the HDD 104, and applies the impression conversion formula to each of the subjective evaluation results obtained in S1211 to obtain impression values of each text. Applying the impression conversion formula obtained in the poster impression quantification process allows the impression of the text to be quantified on dimensions having the same meaning as the impression of the poster.

In S1213, the CPU 101 associates the text and the impression with each other. Although the quantification can be performed on the text subjected to the subjective evaluation in the above-mentioned method, the estimation of the impression needs to be performed also for an unknown text without the subjective evaluation. The association of the text and the impression can be implemented by using, for example, a deep learning method using Transformer, a machine learning method using a decision tree, or the like to train a model that estimates the impression from the text. In the present embodiment, the CPU 101 performs supervised deep learning using Transformer with the text being an input and the four factors being an output. Specifically, the CPU 101 creates a deep learning model by performing training with the text subjected to the subjective evaluation and the corresponding impression being correct answers, and inputs an unknown text into this learning model to estimate the impression.

In S1214, the CPU 101 saves a model configuration and trained parameters of the deep learning model for impression estimation created in S1213, in the HDD 104.

### <Explanation of Operation Mode>

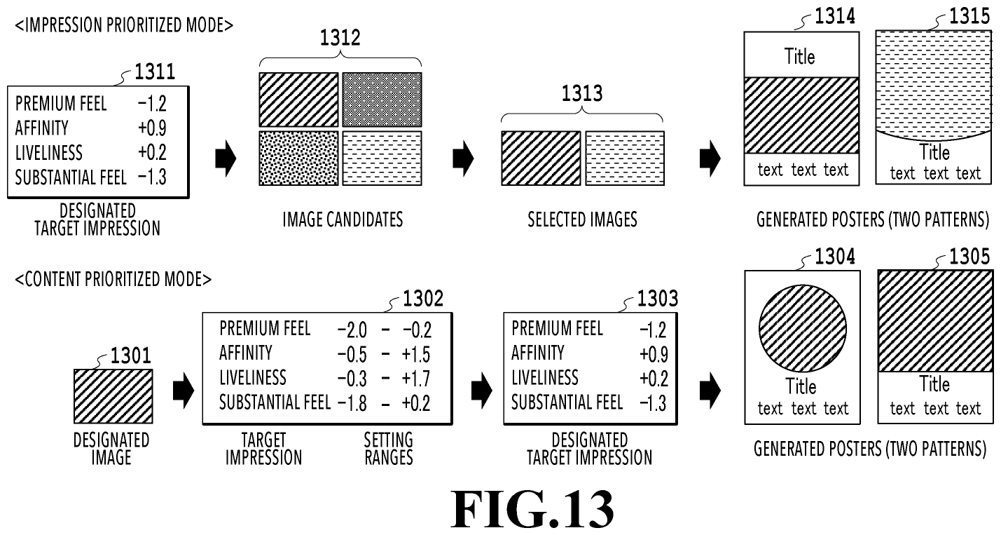

Explanation is given of an outline of differences of the process flows in the content prioritized mode and the impression prioritized mode that are the operation modes of the poster creation application and differences of the posters outputted in these modes, with reference to FIG. 13. Note that, although the case where the content used in the posters is the image is given as the example in FIG. 13, the character information such as the title can be also handled as the content in the present embodiment.

The impression prioritized mode is a mode in which a content suiting the target impression designated by the user is automatically selected. A process flow is as follows. First, the poster creation application receives designation of a target impression 1311 by the user. Next, the poster creation application receives designation, by the user, of candidates 1312 of a content to be used in the poster. In the designation of the candidates of content, the user inputs candidates of title. The user may designate a specific image as a candidate of the image, or designate a directory, a tag, or an application material image itself to designate an image group associated with the directory, the tag, or the application material image in a batch in the image designation screen 801 illustrated in FIG. 8. Moreover, the user may designate multiple images generated by an AI by designating a prompt. The poster creation application selects contents 1313 suiting the designated target impression 1311 from the candidates 1312 of contents. The poster creation application generates posters 1314 and 1315 having impressions close to the target impression by using the selected contents 1313. In the impression prioritized mode, in the case where posters of multiple patterns are generated, contents of varying patterns may be used in the respective posters.

The content prioritized mode is a mode in which the UI for setting the target impression is changed such that a target impression suiting the content to be used in the poster is prioritized. A process flow is as follows. First, the poster creation application receives designation of a content 1301 to be used in the poster, from the user. Next, the poster creation application determines setting ranges 1302 of the target impression suiting the designated content 1301. Then, the poster creation application receives designation of a target impression by the user within the determined setting ranges 1302 of the target impression. The designated target impression is denoted by reference numeral 1303 in FIG. 13. The poster creation application generates posters 1304 and 1305 having impressions close to the designated target impression 1303 by using the designated content 1301. In the content prioritized mode, also in the case where posters of multiple patterns are generated, the content 1301 designated by the user is used in all posters.

As described above, in the impression prioritized mode, the designation of the target impression by the user is the starting point of the process. Meanwhile, in the content prioritized mode, the designation of the content by the user is the starting point of the process. Moreover, in the impression prioritized mode, varying contents may be used in the posters generated depending on the target impression designated by the user. Meanwhile, in the content prioritized mode, the content designated by the user is certainly used in the generated posters. The user can cause the poster generation process to be executed in a creation flow as intended, by selecting one of these operation modes.

### <Operation Mode Switching Process>

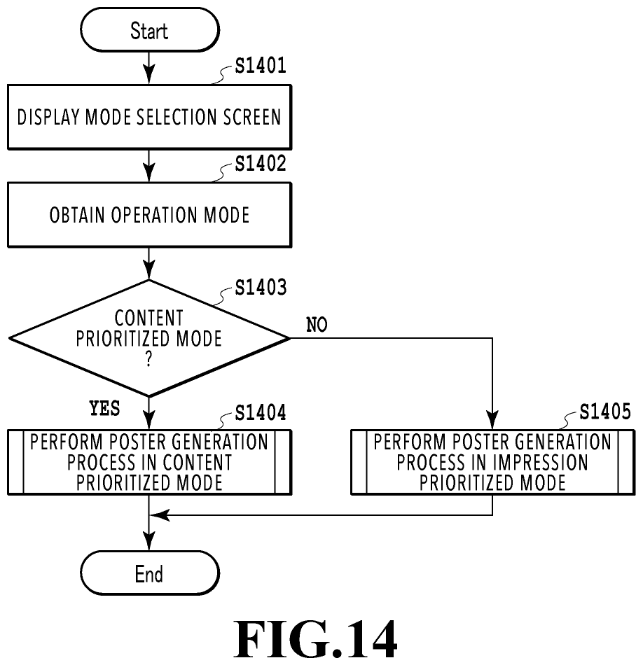

FIG. 14 is a flowchart illustrating an operation mode switching process of the poster creation application. The flowchart illustrated in FIG. 14 is started in the case where the poster creation application is activated by a user operation.

For example, the CPU 101 implements the flowchart illustrated in FIG. 14 by reading out programs stored in the HDD 104 to the RAM 103 and executing the programs. In the present embodiment, explanation is given assuming that the process is executed by the components that are illustrated in FIG. 2 and that function by execution of the above-mentioned poster creation application by the CPU 101. The operation mode switching process is explained with reference to FIG. 14. Note that sign “S” in explanation of each process means step in this flowchart (the same applies below in the present specification).

In S1401, the poster creation application displays the mode selection screen 601 on the display 105. The user designates one of the operation modes displayed in the mode selection screen 601, with the pointing device 107.

In S1402, the operation mode designation component 230 obtains the operation mode designated in the mode selection screen 601.

In S1403, the operation mode designation component 230 determines whether the operation mode obtained in S1402 is the content prioritized mode or the impression prioritized mode. In the case where the operation mode is the content prioritized mode, the process transitions to S1404. In the case where the operation mode is the impression prioritized mode, the process transitions to S1405.

In S1404, the poster generation component 210 executes the poster generation process in the content prioritized mode.

In S1405, the poster generation component 210 executes the poster generation process in the impression prioritized mode.

The process flow of the poster creation application has been described above. Details of the poster generation process in the content prioritized mode executed in S1404 and the poster generation process in the impression prioritized mode executed in S1405 are explained below.

### <Poster Generation Process in Impression Prioritized Mode>

FIGS. 15A and 15B are flowcharts illustrating the poster generation process in the impression prioritized mode. The flowcharts illustrated in FIGS. 15A and 15B are started in the case where the impression prioritized mode is selected in the operation mode switching process described above. For example, the CPU 101 implements the flowcharts illustrated in FIGS. 15A and 15B by reading out programs stored in the HDD 104 onto the RAM 103 and executing the programs. In the present embodiment, explanation is given assuming that the process is executed by the components that are illustrated in FIG. 2 and that function by execution of the above-mentioned poster creation application by the CPU 101. Note that, in the impression prioritized mode, the image impression estimation component 221 and the UI changing component 222 in FIG. 2 are not used. The poster generation process in the impression prioritized mode is explained with reference to FIGS. 15A and 15B.

In S1501, the poster creation application displays the generation condition setting screen 701 illustrated in FIG. 7, on the display 105.

In S1502, the poster creation condition designation component 201, the text designation component 202, the image designation component 203, and the target impression designation component 204 receive settings of setting items displayed on the generation condition setting screen 701, and obtains the set data. The user inputs a setting value of each of the setting items by using the keyboard 106 and the pointing device 107. The image designation component 203 obtains information on the obtaining destination of the image file or the image group. The text designation component 202 obtains the character information inputted in the title box 702, the subtitle box 703, and the main text box 704. The target impression designation component 204 receives designation of the target impression performed by the operation on the impression sliders 708 to 711 or the radio buttons 712, and obtains information on the designated target impression. The poster creation condition designation component 201 receives designation of the poster size, the creation number, the image number, and the use application category of the poster, and obtains the designated information.

In the case where the user has already specifically determined an image desired to be used in the poster, the user sets the radio button 802 of the image designation screen 801 illustrated in FIG. 8 to on, and designates the file path of the image data in the designation box 808. In the case where the image desired to be used in the poster is the material image in the application or the external cooperation material image, the user sets the radio button 804 or the radio button 805 to on, and designates the file path of the material image data in the designation box 812 or the designation box 814.

In the case where the user has not specifically determined the image desired to be used in the poster, the user sets the radio button 803 of the image designation screen 801 illustrated in FIG. 8 to on, and designates a folder path of an image folder in the designation box 810. Multiple pieces of image data stored in the designated image folder can be thereby designated in a batch as the image group. Alternatively, the user can designate all application material images as the image group by setting the radio button 804 for the application material images (all) to on. Alternatively, the user can designate multiple images as the candidates of image (image group) by setting the radio button 802, 805, or 806 to on and designating file paths of multiple pieces of image data in the designation box 808, 812, or 814. Alternatively, the user can designate images generated by the AI as the candidates of image (image group). In this case, the user sets the radio button 807 to on, and designate a prompt for causing the image generative AI to generate the images in the prompt box 816.

In S1503, the image obtaining component 211 obtains the image data. Specifically, the image obtaining component 211 reads out the image data or the image group designated by the user in the image designation component 203, from the designated obtaining destination (for example, HDD 104) to the RAM 103.

In S1504, the content selection component 220 executes the content selection process. Specifically, the content selection component 220 selects the image data to be used in the poster from the image data or the image group obtained in S1503. Moreover, the content selection component 220 obtains the title character information in the character information designated in the text designation component 202 in S1502, and selects the title character information to be used in the poster from the obtained character information. The image selected by the content selection component 220 may be displayed in the image designation region 705 of the generation condition setting screen 701. Moreover, the title selected by the content selection component 220 may be displayed in the title box 702 or the additional title box 719 of the generation condition setting screen 701.

### <Content Selection Process>

The content selection process executed in S1504 is explained in detail with reference to FIG. 16. FIG. 16 is a flowchart explaining S1504 in detail. The process of the present flowchart is executed by the determination component 301, the content impression estimation component 302, the content evaluation component 303, and the content selection component 304 of the content selection component 220 illustrated in FIG. 3.

In S1601, the determination component 301 determines whether multiple pieces of title character information are obtained from the text designation component 202. In the case where there are multiple pieces of title character information, the process transitions to S1602. In the case where there is one piece of title character information, the title can be uniquely determined. Accordingly, the content selection component 220 selects this title and holds the title in the RAM 103, and the process transitions to S1605.

In S1602, the content impression estimation component 302 estimates an impression of each of the multiple titles (character information) by using the trained model generated in the content impression quantification process illustrated in FIG. 12B.

In S1603, the content evaluation component 303 determines a distance that is information indicating a difference between the target impression obtained in S1502 and the impression of each title (character information) estimated in S1602. In the present embodiment, a Euclidean distance is used as the distance. The smaller the value of the distance is, the closer the impression of the title is to the target impression.

In S1604, the content selection component 304 selects top N titles in ascending order of the value of the distance determined in S1603. In the present embodiment, the content selection component 304 selects top one title. The content selection component 304 holds the selected title in the RAM 103.

Note that the setting method of the selection number N of the title may be such that the selection number N is a fixed value or is variable depending on the conditions designated in the poster creation condition designation component 201. For example, in the case where the creation number is designated to be six in the creation number box 714 on the generation condition setting screen 701, the poster generation component 210 generates six posters. In the layout component 217 described later, the posters are generated by combining the skeletons, the color scheme patterns, and the fonts selected in the skeleton selection component 214, the color scheme pattern selection component 215, and the font selection component 216. Accordingly, for example, selecting two skeletons, two color scheme patterns, and two fonts enables generation of 2×2×2=8 posters, and this can satisfy the condition of the creation number of six. The selection number N of the title may be determined depending on the conditions designated in the poster creation condition designation component 201 as described above.

Moreover, in the case where the minimum value of the distance determined in S1603 is larger than a predetermined threshold, the content selection component 304 may display a warning screen indicating that there is no title having an impression close to the target impression, on the display 105.

In S1605, the determination component 301 determines whether the image number designated in the poster creation condition designation component 201 is not zero. In the case where the image number is not zero (S1605; YES), the process transitions to S1606. In the case where the image number is zero (S1605; NO), selection of image is unnecessary. Accordingly, the present flowchart is terminated, and the process transitions to S1505 of FIG. 15A.

In S1606, the determination component 301 determines whether the number of pieces of image data (candidate image number) obtained by the image obtaining component 211 in S1503 is larger than the image number designated in the poster creation condition designation component 201 or not. In the case where the number of pieces of image data (candidate image number) obtained by the image obtaining component 211 is larger (S1606; YES), the process transitions to S1607. In the case where the number of pieces of image data (candidate image number) obtained by the image obtaining component 211 is equal to the image number designated in the poster creation condition designation component 201 (S1606; NO), the image to be used is uniquely determined. Accordingly, the determined image is selected and held in the RAM 103. Then, the present flowchart is terminated, and the process transitions to S1505 of FIG. 15A. Note that, in the case where the number of pieces of image data (candidate image number) obtained by the image obtaining component 211 is smaller than the image number designated in the poster creation condition designation component 201, the process of prompting addition of an image is performed at a time point where the OK button 717 of the generation condition setting screen 701 is pressed as described above.

In S1607, the content impression estimation component 302 estimates the impression of each of the multiple pieces of image data by using the trained model generated by the content impression quantification process illustrated in FIG. 12A.

In S1608, the content evaluation component 303 determines a distance between the target impression obtained in S1502 and the impression of each piece of image data estimated in S1607. The smaller the value of the distance is, the closer the impression estimated from the image data is to the target impression.

In S1609, the content selection component 304 selects top N pieces of images data in ascending order of the value of the distance determined in S1608, and holds the image data in the RAM 103. In the present embodiment, the content selection component 304 selects pieces of image data as many as the image number designated in the poster creation condition designation component 201. Note that, as in the case of the text, the setting method of the selection number N is not limited to this, and the selection number N may be variable depending on the conditions designated in the poster creation condition designation component 201. Moreover, in the case where the minimum value of the distance determined in S1607 is larger than a predetermined threshold, the content selection component 304 may display a warning screen indicating that a candidate of image giving an impression close to the target impression is absent, on the display 105.

In the case where the process of S1609 is completed, the present flowchart is terminated, and the process proceeds to S1505 of FIG. 15A. The content selection process of the present flowchart achieves a state where one title and the designated number of pieces of image data are selected.

Returning to FIG. 15A, in S1505, the selection numbers are determined such that posters corresponding to the creation number designated in the poster creation condition designation component 201 can be generated. Specifically, the skeleton selection component 214 determines the number of skeletons to be selected, the color scheme pattern selection component 215 determines the number of color scheme patterns to be selected, and the font selection component 216 determines the number of fonts to be selected. In the present embodiment, the layout component 217 is assumed to generate pieces of poster data as many as the number of skeletons×the number of color scheme patterns×the number of fonts by a method to be described later. The skeleton selection component 214, the color scheme pattern selection component 215, and the font selection component 216 determine the number of skeletons to be selected, the number of color scheme patterns to be selected, and the number of fonts to be selected such that the number of posters to be generated is equal to or more than the creation number (number designated in the creation number box 714 in FIG. 7) designated in the poster creation condition designation component 201. For example, the number of skeletons, the number of color scheme patterns, and the number of fonts may each be determined according to Formula 1 described below.

$$selection number = ⌈ \sqrt[3]{creation number \times 2} ⌉ \qquad ( 1 )$$

where ┌x┐ is the number of ceiling functions, and is the smallest integer that is not smaller than x.

For example, in the case where the creation number is six, the selection number is three, the number of pieces of poster data to be generated by the layout component 217 is 27, and the poster selection component 219 selects six out of the 27 pieces of poster data. The poster selection component 219 can thereby select posters whose impressions of the entire posters further match the target impression, from among the pieces of poster data generated as many as or more than the creation number. Note that the method of determining the selection number is not limited to this, and the selection number may be determined by another method. Moreover, the selection number may be a fixed value.

In S1506, the image analysis component 212 executes the analysis process on the image data selected in the content selection process (FIG. 16) of S1504, and obtains information indicating the feature amounts relating to each image. The information indicating the feature amounts includes, for example, meta information stored in the image and the information indicating the image feature amounts that can be obtained by analyzing the image. These pieces of information are used in the object recognition process that is the analysis process. Note that, although the object recognition process is executed as the analysis process in the present embodiment, the present disclosure is not limited to this, and other analysis processes may be executed. Moreover, the process of S1506 may be omitted. Details of the process performed in the image analysis component 212 in S1506 are explained below.

The image analysis component 212 executes the object recognition process on each image selected in S1504. In this case, a publicly-known method can be used for the object recognition process. In the present embodiment, objects are recognized by a discriminator created by deep learning. The discriminator outputs a likelihood of whether a certain pixel forming the image is a pixel forming each object or not in a value of 0 to 1, and recognizes that the object is in the image for the object exceeding a certain threshold. The image analysis component 212 can obtain the types and positions of the objects such as face, flower, food, building, stationary object, landmark, and pets including dog, cat, and the like by recognizing an object image.

In S1507, the skeleton obtaining component 213 obtains the skeletons matching various setting conditions. In the present embodiment, the skeletons are assumed to be such that one skeleton is described in one file and saved in the HDD 104. The skeleton obtaining component 213 sequentially reads out the skeleton files from the HDD 104 to the RAM 103, and keeps the skeletons matching the setting conditions on the RAM 103 while deleting the skeletons not matching the conditions from the RAM 103. FIG. 15B is a flowchart of a condition determination process performed by the skeleton obtaining component 213 in S1507. The condition determination process executed by the skeleton obtaining component 213 is explained with reference to FIG. 15B.

In S1521, for each of the skeletons read into the RAM 103, the skeleton obtaining component 213 determines whether the poster size designated in the poster creation condition designation component 201 matches the size of the skeleton. Note that, although the size match is checked in this process, matching of the aspect ratio alone is sufficient. In this case, the skeleton obtaining component 213 enlarges or reduces the coordinate system of the read skeleton to obtain a skeleton matching the poster size designated in the poster creation condition designation component 201.

In S1522, the skeleton obtaining component 213 determines whether the use application category designated in the poster creation condition designation component 201 matches the category of the skeleton. The use application category of the skeleton to be used only for a specific use application is described in the skeleton file, and this skeleton is prevented from being obtained except for the case where this use application category selected. This can prevent the skeleton from being used in other use application categories in the case where the skeleton is designed specifically for a certain use application such as, for example, the case where a pattern invoking school is graphically drawn by a graphic or the case where a pattern of sport goods is graphically drawn. Note that, in the case where no use application category is set in the generation condition setting screen 801, S1522 is skipped. Note that, in the case where no use application category is set in the generation condition setting screen 701, S1522 is skipped.

In S1523, the skeleton obtaining component 213 determines whether the number of image objects in the read skeleton matches the image number designated in the poster creation condition designation component 201. Note that, although the example in which whether the number of image objects in the skeleton matches the image number designated in the poster creation condition designation component 201 is determined is described in the present embodiment, the present disclosure is not limited to this, and whether the number of image objects in the skeleton is equal to or less than the designated image number may be determined. In this case, some of the posters generated by the poster generation component 210 are posters that do not satisfy the image number designated by the user. Specifically, in the case where the image number designated in the poster creation condition designation component 201 is three, the posters in which the image number is three, the posters in which the image number is two, and the posters in which the image number is one are also generated. Accordingly, A it is possible to generate posters of image selection patterns more than the posters generated in the case where the number of image objects in the skeleton matches the image number designated in the poster creation condition designation component 201.

In S1524, the skeleton obtaining component 213 determines whether the text object of the read skeleton matches the character information designated in the text designation component 202. More specifically, the skeleton obtaining component 213 determines whether each type of character information designated in the text designation component 202 is present in the skeleton. For example, assume that character strings are designated in the title box 702 and the main text box 704 on the generation condition setting screen 701, and blank is designated in the subtitle box 703. In this case, the skeleton obtaining component 213 searches all text objects in the skeleton, and determines that the skeleton is suitable in the case where the text object for which “title” is set as the type of character information in the metadata and the text object for which “main text” is set as the type are both found, and determines that the skeleton is unsuitable in other cases. In the case where the text object of the read skeleton matches the character information designated in the text designation component 202, the skeleton obtaining component 213 keeps this skeleton in the RAM 103. In the case where the text object does not match the character information, the skeleton obtaining component 213 deletes this skeleton from the RAM 103.

As described above, the skeleton obtaining component 213 keeps the skeletons in which the size, the use application category, the number of image objects, and the type of text object of the skeleton all match the conditions set in the generation condition setting screen 701, on the RAM 103. Note that, although the skeleton obtaining component 213 performs the determination for all skeleton files on the HDD 104 in the present embodiment, the present disclosure is not limited to this. For example, the poster creation application may hold a database in which file paths of the skeleton files are associated with the search conditions (skeleton size, the number of image objects, and type of text object) in advance, in the HDD 104. In this case, the skeleton obtaining component 213 can obtain the skeleton files at high speed by reading only the skeleton files determined to match the conditions as a result of searching on the database, from the HDD 104 to the RAM 103. Explanation returns to FIG. 15A.

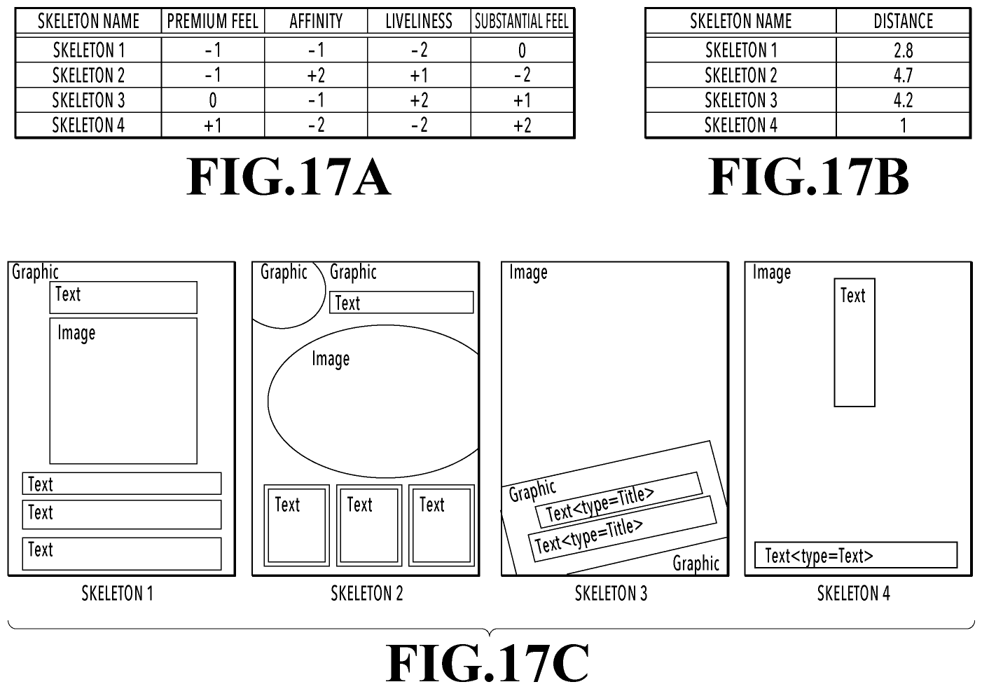

In S1508, the skeleton selection component 214 selects the skeletons matching the target impression designated in the target impression designation component 204 among the skeletons obtained in S1507. FIGS. 17A to 17C are diagrams explaining a method by which the skeleton selection component 214 selects the skeletons. FIG. 17A is a diagram illustrating an example of a table in which the skeletons are associated with the impressions. In the column of skeleton name in FIG. 17A, a file name of each skeleton is described, and the columns of premium feel, affinity, liveliness, and substantial feel each illustrate a number (numerical value) indicating a level of an influence of the skeleton on a corresponding one of the impression factors. This numerical value is a value indicating that −2 is low, −1 is slightly low, 0 is neither high nor low, +1 is slightly high, and +2 is high for the impression. First, the skeleton selection component 214 determines a distance between the target impression obtained from the target impression designation component 204 and the impression of each of the skeletons illustrated in the skeleton impression table of FIG. 17A. For example, in the case where the target impression is “premium feel +1, affinity −1, liveliness −2, and substantial feel +2”, the distance determined by the skeleton selection component 214 is as illustrated in FIG. 17B. Note that, in the present embodiment, a Euclidean distance is used as the distance (hereinafter, mere distance means Euclidean distance). The smaller the value indicated by the Euclidean distance is, the closer the impression of the skeleton is to the target impression. Next, the skeleton selection component 214 selects top N skeletons in ascending order of the value indicated by the distance in FIG. 17B, N being the selection number. In the present embodiment, the skeleton selection component 214 is assumed to select top two skeletons. Specifically, the skeleton selection component 214 selects Skeleton 1 and Skeleton 4.

As described above, the selection number N of the skeletons may be a fixed value or a value that is variable depending on the conditions designated in the poster creation condition designation component 201. In the case where the selection number N is a variable value, the selection number N may be determined by Formula 1 described above, or determined by another method. For example, in the case where the creation number is designated to be six in the creation number box 714 on the generation condition setting screen 701, the poster generation component 210 generates six posters. In the layout component 217 to be described later, the posters are generated by combining the skeletons, the color scheme patterns, and the fonts selected in the skeleton selection component 214, the color scheme pattern selection component 215, and the font selection component 216. Accordingly, for example, selecting two skeletons, two color scheme patterns, and two fonts enables generation of 2×2×2=8 posters, and this can satisfy the condition of the creation number of six. The number N of skeletons to be selected may be determined depending on the conditions designated in the poster creation condition designation component 201 as described above.

Moreover, each of the ranges of the impression in the skeleton impression table in FIG. 17A does not have to be the same as the corresponding range of the impression designated in the target impression designation component 204. Although the range of the impression designated in the target impression designation component 204 is −2 to +2 in the present embodiment, the range of the impression in the skeleton impression table may be different from this range. In this case, the range in the skeleton impression table is scaled to match the range of the target impression, and then the above-mentioned distance calculation is executed. Furthermore, the distance determined by the skeleton selection component 214 is not limited to the Euclidean distance, and may be a Manhattan distance, a Cosine similarity, or the like as long as a distance between vectors can be determined. Moreover, the impression factors set to off with the radio buttons 712 are excluded from the distance determination calculation.

Note that, for example, the skeleton impression table is created in advance by estimating an impression of a poster image generated based on each skeleton with the color scheme pattern, the font, and the image and character data arranged on the skeleton fixed. Then, the skeleton impression table is saved in the HDD 104. Specifically, the impression of each of the poster images that are the same in the used images, the colors of used characters, and the like but vary in the arrangement of the characters, images, and the like is estimated, and characteristics relative to other skeletons are thereby formed into a table. In this case, it is desirable to perform a process of cancelling impressions given by the used color scheme pattern, image, and the like such as performing standardization across all estimated impressions, averaging impressions of multiple poster images generated from one skeleton by using multiple color scheme patterns and multiple images, or the like. Influences of the arrangement on the impression can be thereby formed into a table, the influences being, for example, such an influence that an impression of a skeleton with a small image is determined based on elements such as graphics and characters irrespective of the image and such an influence that liveliness is high in the case where images and characters are arranged in a tilted manner.

FIG. 17C illustrates examples of skeletons corresponding to Skeleton 1 to Skeleton 4 in FIG. 17A. For example, in Skeleton 1, an image object and text objects are regularly arranged, and the area of the image is small. Accordingly, liveliness is low. In Skeleton 2, a graphical object and an image object are circular. Accordingly, affinity is high, and substantial feel is low. In Skeleton 3, an image object is arranged in a large area, and a tilted graphical object is arranged to be laid over the image object. Accordingly, liveliness is high. In Skeleton 4, an image is arranged over the entire skeleton, and a text object is minimized. Accordingly, substantial feel is high, and liveliness is low. As described above, in the case where the poster image includes characters or an image, poster images varying in the target impression are generated by the arrangement method of the characters or the image. Note that the method of creating the skeleton impression table is not limited to this, and the skeleton impression table may be estimated from characteristics of arrangement information itself such as areas and coordinates of images and title character strings, or may be manually adjusted. The skeleton impression table is saved in the HDD 104, and the skeleton selection component 214 reads out the skeleton impression table from the HDD 104 to the RAM 103, and refers to the skeleton impression table.

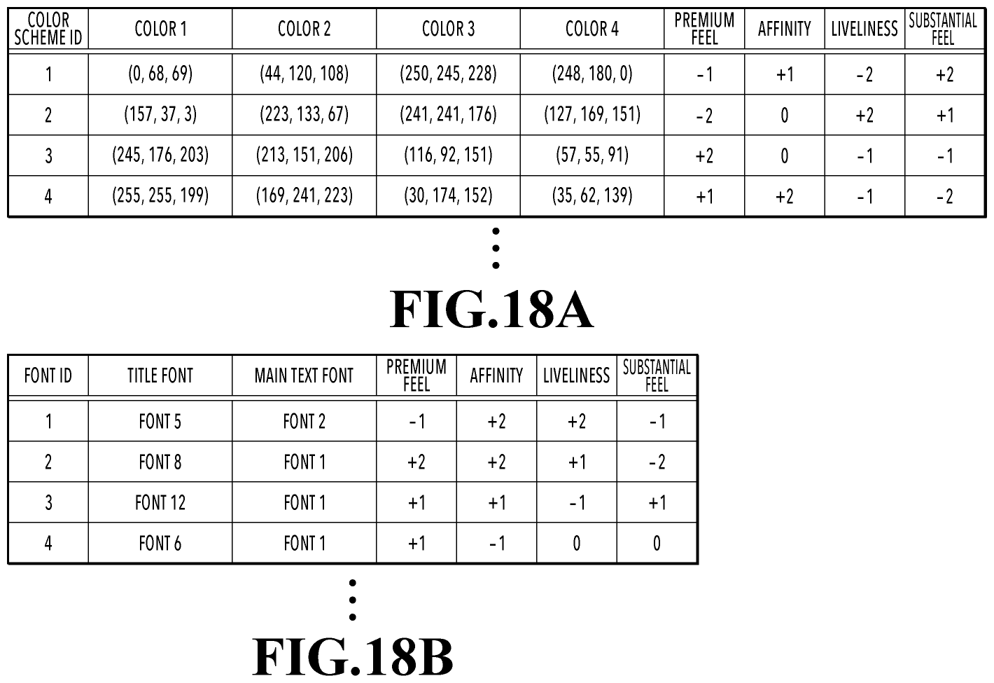

In S1509, the color scheme pattern selection component 215 selects the color scheme patterns matching the target impression designated in the target impression designation component 204. The color scheme pattern selection component 215 refers to an impression table corresponding to the color scheme patterns, and selects the color scheme patterns depending on the target impression, in a method similar to S1507. FIG. 18A illustrates an example of the color scheme pattern impression table in which the color scheme patterns are associated with the impressions. The color scheme pattern selection component 215 determines a value of a distance between the target impression and a value of a distance of an impression indicated by the columns of premium feel to solid feel in FIG. 18A, and selects top N color scheme patterns in ascending order of the value of the distance, N being the selection number. In the present embodiment, top two color scheme patterns are assumed to be selected. Note that, like the skeleton impression table, in the color scheme pattern impression table, tendencies of impressions of the color scheme patterns can be formed into a table by: creating posters varying in the color scheme pattern with the elements other than the color scheme pattern such as the skeleton, the font, and the image fixed; and estimating the impressions of the posters.

In S1510, the font selection component 216 selects combinations of fonts matching the target impression designated in the target impression designation component 204. The font selection component 216 refers to an impression table corresponding to the fonts, and selects the fonts depending on the target impression, in a method similar to S1507. FIG. 18B illustrates an example of the font impression table in which the fonts are associated with the impressions. The font selection component 216 determines a value of a distance between the target impression and a value of an impression indicated by the columns of premium feel to substantial feel in FIG. 18B, and selects top N fonts in ascending order of the value of the distance, N being the selection number. Note that, like the skeleton impression table, in the font impression table, tendencies of impressions of the fonts can be formed into a table by: creating posters varying in the font with the elements other than the font such as the skeleton, the color scheme pattern, and the image fixed; and estimating the impressions of the posters.

In S1511, the layout component 217 sets the character information, the images, the color schemes, and the fonts for the skeletons selected in the skeleton selection component 214, and generates posters.

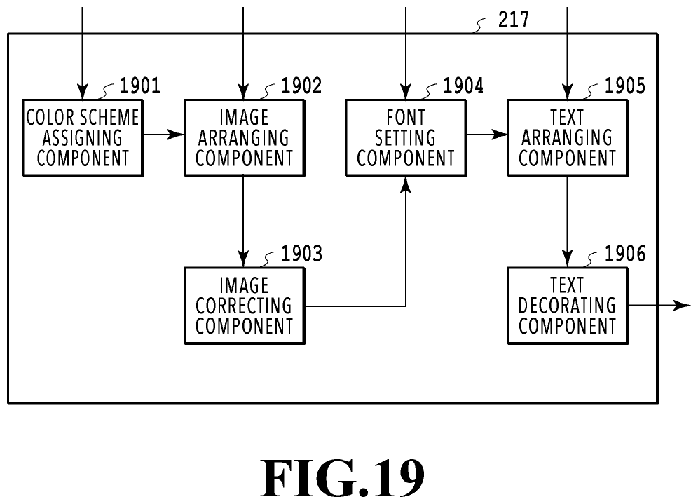

Next, the process of S1511 and a software configuration of the layout component 217 are explained in detail by using FIGS. 19, 20, 21A to 21C, and 22A to 22C.

FIG. 19 is an example of a software block diagram explaining the layout component 217 in detail. The layout component 217 includes a color scheme assigning component 1901, an image arranging component 1902, an image correcting component 1903, a font setting component 1904, a text arranging component 1905, and a text decorating component 1906.

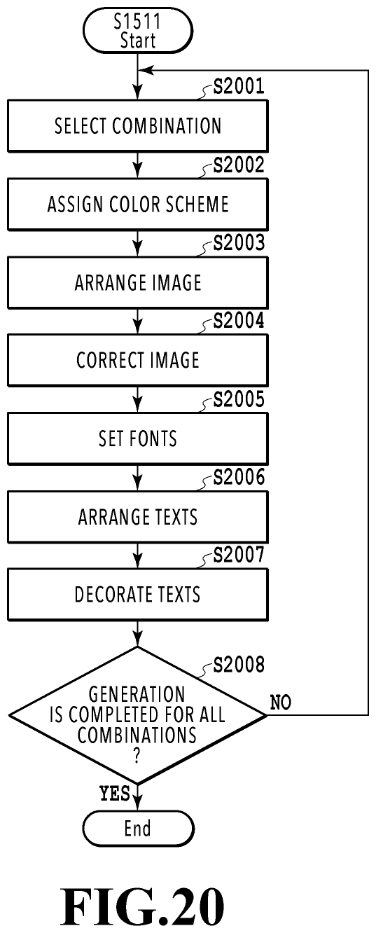

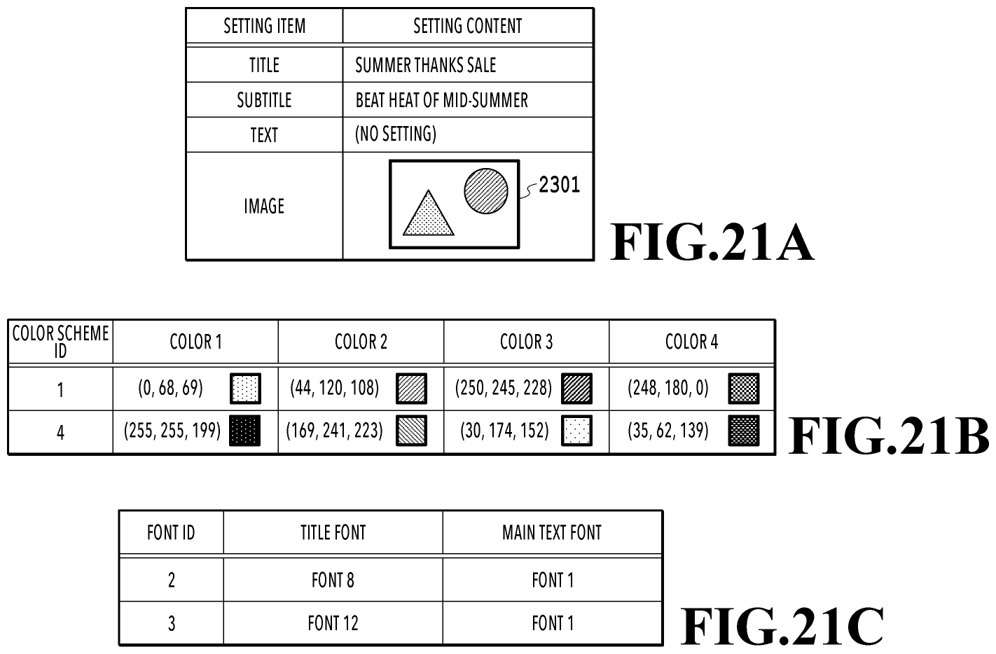

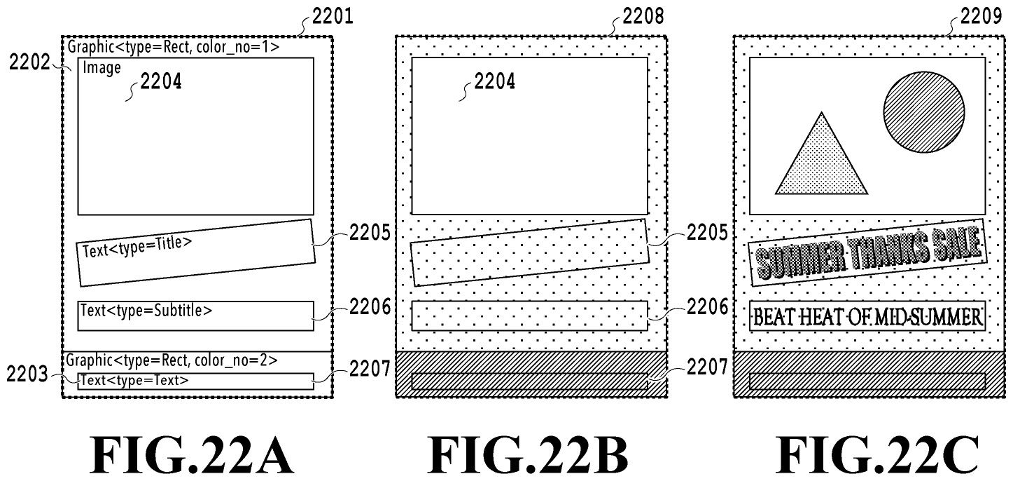

FIG. 20 is a flowchart explaining the layout process of S1511 in detail. Moreover, FIGS. 21A to 21C are diagrams explaining information inputted into the layout component 217. FIG. 21A is a table summarizing the character information designated in the text designation component 202 and image data 2101 selected in the content selection component 220. FIG. 21B is an example of a table illustrating the color scheme patterns obtained from the color scheme pattern selection component 215, and FIG. 21C is an example of a table illustrating the fonts obtained from the font selection component 216. FIGS. 22A to 22C are diagrams explaining a procedure of the process of the layout component 217.

First, the layout process of S1511 is explained in detail by using FIG. 20.

In S2001, the layout component 217 lists all combinations of the skeletons obtained from the skeleton selection component 214, the color scheme patterns obtained from the color scheme pattern selection component 215, and the fonts obtained from the font selection component 216. The layout component 217 sequentially generates pieces of poster data for the respective combinations by performing the layout process of S2002 and beyond. For example, in the case where: the number of skeletons obtained from the skeleton selection component 214 is three; the number of color scheme patterns obtained from the color scheme pattern selection component 215 is two; and the number of fonts obtained from the font selection component 216 is two, the layout component 217 generates 3×2×2=12 pieces of poster data. Next, in S2001, the layout component 217 selects one of the listed combinations, and executes the processes of S2002 to S2007. Note that there are cases where the content selection component 304 selects more than one title in S1604 or selects more images than the image number designated in the poster creation condition designation component 201 in S1609. In these cases, the layout component 217 lists combinations taking also the titles and the images into consideration.

In S2202, the color scheme assigning component 1901 assigns the color scheme pattern obtained from the color scheme pattern selection component 215, to the skeleton obtained from the skeleton selection component 214. FIG. 22A is a diagram illustrating an example of the skeleton. In the present embodiment, explanation is given of an example in which a color scheme pattern with a color scheme ID of 1 in FIG. 21B is assigned to a skeleton 2201 in FIG. 22A. The skeleton 2201 in FIG. 22A is formed of two graphical objects 2202 and 2203, one image object 2204, and three text objects 2205, 2206, and 2207. First, the color scheme assigning component 1901 assigns colors to each of the graphical objects 2202 and 2203. Specifically, the color scheme assigning component 1901 assigns a corresponding color from the color scheme pattern, based on a color scheme number that is metadata described in the graphical object. Next, the color scheme assigning component 1901 assigns, for example, the last color in the color scheme pattern to the text object (Text<type=Title>) whose metadata is type and whose attribute is “title” among the text objects. Specifically, in the present embodiment, Color 4 is assigned to the characters arranged in the text object 2205. Next, the color scheme assigning component 1901 sets a character color for characters arranged in each of the text objects 2206 and 2207 whose metadata is type and whose attributes are attributes other than “title” among the text objects, based on brightness of a background of the text object. In the present embodiment, the character color is set to white in the case where the brightness of the background of the text object is equal to or lower than a threshold, and is set to black if not. FIG. 22B is a diagram illustrating a state of a skeleton 2208 after execution of the color scheme assigning process described above. The color scheme assigning component 1901 outputs the skeleton data 2208 subjected to the color scheme assignment to the image arranging component 1902.

In S2003, the image arranging component 1902 arranges the image data obtained from the image analysis component 212 on the skeleton data 2208 obtained from the color scheme assigning component 1901, based on attached analysis information. In the case where the image analysis by the image analysis component 212 is not performed, the image arranging component 1902 arranges the image data selected by the content selection component 220 on the skeleton data 2208. In the present embodiment, the image arranging component 1902 assigns the image data 2101 to the image object 2204 in the skeleton. Moreover, in the case where the aspect ratio of the image object 2204 varies from that of the image data 2101, the image arranging component 1902 crops the image data 2101 such that the aspect ratio of the image data 2101 matches the aspect ratio of the image object 2204. More specifically, the image arranging component 1902 crops the image data 2101 based on a position of an object obtained by analyzing the image data 2101 with the image analysis component 212 such that an object region reduced by the cropping is minimized. Note that the cropping method is not limited to this, and other cropping methods such as, for example, cropping a center portion of the image or adjusting a composition such that a face position forms a triangular composition may be used. The image arranging component 1902 outputs the skeleton data subjected to the image assignment to the image correcting component 1903.

In S2004, the image correcting component 1903 obtains the skeleton data subjected to the image assignment from the image arranging component 1902, and corrects the image arranged in the skeleton. In the present embodiment, in the case where the resolution of the image is insufficient, an up-sampling process by a super-resolution process is performed. First, the image correcting component 1903 determines whether the image arranged in the skeleton satisfies a certain resolution. For example, assume that an image of 1,600 px×1,200 px is assigned to a region of 200 mm×150 mm on the skeleton. In this case, the print resolution of the image can be calculated by using Formula 2.

$$\frac{1600}{200 \div 25.4} \approx 203 [ dpi ] \qquad ( 2 )$$

Next, in the case where the image correcting component 1903 determines that the print resolution of the image is lower than a threshold, the image correcting component 1903 improves the resolution by performing the super-resolution process. Meanwhile, in the case where the image correcting component 1903 determines that the print resolution of the image is equal to or higher than the threshold and the image has a sufficient resolution, no particular image correction is performed. In the present embodiment, the super-resolution process is performed in the case where the print resolution of the image is lower than 300 dpi.

In S2005, the font setting component 1904 sets the fonts obtained from the font selection component 216 for the skeleton data obtained from the image correcting component 1903 and subjected to the image correction. FIG. 21C is an example of the combinations of fonts selected by the font selection component 216. In the present embodiment, explanation is given of an example of assigning fonts in the case where the fonts assigned to the skeleton data subjected to the image correction are fonts of font ID “2” in FIG. 21C. In the present embodiment, the fonts are set for the text objects 2205, 2206, and 2207 in the skeleton 2208. Note that, in the poster, a font that stands out is set for the title from the viewpoint of noticeability, and a font that is easily readable is set for characters other than the title from the viewpoint of viewability in many cases. Accordingly, in the present embodiment, the font selection component 216 selects two types of fonts that are a title font and a main text font. The font setting component 1904 sets the title font for the text object 2205 whose attribute is “title”, and sets the main text font for the other text objects 2206 and 2207. The font setting component 1904 outputs the skeleton data subjected to the font setting to the text arranging component 1905. Note that, although the font selection component 216 selects two types of fonts in the present embodiment, the present disclosure is not limited to this, and for example, only the title font may be selected. In this case, the font setting component 1904 uses a font corresponding to the title font as the main text font. Specifically, the main text font matching the type of the title font may be set as follows: for example, in the case where a font of a Gothic family is used for the title, a typical Gothic font with high readability is used for the other text objects, and in the case where a font of a Ming family is used for the title, a typical Ming font is used for the other text objects. As a matter of course, the title font and the main text font may be identical. Moreover, different fonts may be used as follows depending on a degree at which the text objects are desired to be made noticeable: for example, the title font is used for the text objects of the title and the subtitle while the main text font is used for the other text objects; or the title font is used for characters of a certain font size or larger.

In S2206, the text arranging component 1905 arranges the texts designated in the text designation component 202 and the texts selected in the content selection component 220 on the skeleton data obtained from the font setting component 1904 and subjected to the font setting. In the present embodiment, texts illustrated in FIG. 21A are assigned with reference to the attributes of metadata of the text objects in the skeleton. Specifically, “Summer Thanks Sale” whose attribute is title is assigned to the text object 2205, and “Beat Heat of Mid-Summer” whose attribute is subtitle is assigned to the text object 2206. Since no main text is set, nothing is assigned to the text object 2207. FIG. 22C illustrates a skeleton 2209 that is an example of skeleton data after the process by the text arranging component 1905. The text arranging component 1905 outputs the skeleton data 2209 subjected to the text arrangement to the text decorating component 1906.

In S2207, the text decorating component 1906 decorates the text objects in the skeleton obtained from the text arranging component 1905 and subjected to the text arrangement. In the present embodiment, in the case where a color difference between the title character and a background region of the title character is equal to or less than a threshold, a process of adding an outline to the title character is performed. This improves the readability of the title. The text decorating component 1906 outputs the decorated skeleton data, that is the poster data for which the layout is completely finished, to the poster impression estimation component 218.

In S2008, the layout component 217 determines whether the poster data is generated in all combinations. In the case where the layout component 217 determines that the poster data is generated in all combinations of the skeletons, the color scheme patterns, and the fonts, the layout component 217 terminates the layout process, and transitions to S1512. In the case where the layout component 217 determines that the poster data is not generated in all combinations, the process returns to S2001, and the poster data is generated in a combination in which the poster data is not generated yet.

The layout process of S1511 has been described above. Description returns to the explanation of FIG. 15A.

In S1512, the poster impression estimation component 218 associates an estimated impression, obtained by executing a rendering process on each piece of poster data obtained from the layout component 217 and estimating the impression of the rendered poster image, with the poster data. Note that the rendering process is a process of converting the poster data to the image data. For example, even in posters of the same color scheme pattern, the arrangement varies in the case where the skeleton varies. Accordingly, an area in which each color is actually used varies. Thus, it is necessary to evaluate not only the tendency of the impression of each of the color scheme patterns and the skeletons but also the impression of the final poster. Accordingly, the present process is executed at this timing. This allows evaluation of not only the impression of each of the elements in the poster such as the color scheme and the arrangement but also the impression of the final poster in which the image and the characters are included and laid out.

In S1513, the poster selection component 219 selects the poster to be outputted to the display 105 (to be presented to the user) based on the pieces of poster data obtained from the poster impression estimation component 218 and the estimated impressions associated with the pieces of poster data. In the present embodiment, the poster selection component 219 selects a poster in which a value of a distance between the target impression and the estimated impression of the poster is equal to or less than a predetermined threshold.

Note that a Euclidean distance is used as the distance in the present embodiment. The smaller the value indicated by the Euclidean distance is, the closer the estimate impression and the target impression are to each other. Moreover, the distance determined by the poster selection component 219 is not limited to the Euclidean distance, and may be a Manhattan distance, a Cosine similarity, or the like as long as a distance between vectors can be determined.

Moreover, in the case where the number of selected posters is less than the creation number designated in the poster creation condition designation component 201, the poster selection component 219 selects posters for filling an insufficient amount, in ascending order of the value of the distance between the target impression and the estimated impression of each poster. Note that, although the poster selection component 219 selects the posters filling the insufficient amount in the present embodiment, the present disclosure is not limited to this. For example, in the case where the number of posters selected by the poster selection component 219 is less than the creation number, information indicating that the number of posters is insufficient may be displayed on the poster preview screen 901 (FIG. 9). Alternatively, the poster selection component 219 may select the posters filling the insufficient amount, and then display the posters on poster preview screen 901 such that the posters for which the value of the distance between the target impression and the estimated impression is equal to or smaller than the threshold are distinguishable from the posters for which the value is larger than the threshold. Moreover, for example, the configuration may be such that, in the case where the number of selected posters is insufficient, the process returns to S1505, and the selection numbers of the skeletons, the color scheme patterns, and the fonts are increased.

In S1514, the poster display component 205 renders each piece of poster data selected by the poster selection component 219, and outputs the poster image to the display 105. Specifically, the poster image is displayed on the poster preview screen 901 of FIG. 9.

The poster generation process (S1405) in the impression prioritized mode has been explained above. As explained above, in the poster generation process in the impression prioritized mode, the poster creation application receives designation of the target impression by the user, and selects contents such as the image and the text to be arranged in the poster from the content groups, based on the received target impression. In this case, the poster creation application selects contents suiting the target impression designated by the user, from the content groups. Specifically, the poster creation application selects contents estimated to give impressions close to the target impression, as the contents suiting the target impression designated by the user. Moreover, the poster creation application generates a poster based on the target impression designated by the user, while using the selected contents. As a result, a first content selected in the case where designation of a first target impression is received is different from a second content selected in a case where designation of a second target impression different from the first target impression is received. As a result, posters in which different contents are arranged depending on the target impression are generated.

Accordingly, in the case where the impression prioritized mode is set, a poster with an intended design is likely to be generated also in the case where the contents desired to be used are not clearly determined. As a specific example, there is a case where the user considers to create a poster with a calm impression, but cannot prepare suitable images by himself/herself. In such a case, the user designates “calm impression” as the target impression. Then, the poster creation application automatically finds images suiting creation of the poster with the calm impression, from the image group including images with various impressions, and automatically generates a poster close to the target impression. This reduces the number of times of trial until a poster in which contents suiting the target impression are arranged is obtained, and facilitates obtaining of the poster with the intended design. Note that a similar operation can be performed not only for an image but also for character information such as the title. In the case where the user cannot determine a suitable title by himself/herself and the user designates the target impression, the poster creation application automatically finds the suitable title from a text group including character strings with various impressions, and automatically generates a poster close to the target impression.

Note that, although the text designation component 202 is configured to receive the inputs of character strings into the title box 702 and the additional title box 719 in the generation condition setting screen 701 by the user in the above-mentioned embodiment, the present disclosure is not limited to this. Candidates of text can be obtained from the user by causing the user to designate an obtaining destination of a text group including multiple texts as in the image designation screen 801 illustrated in FIG. 8. In this case, a material text (application material text) created in advance for the present application, a material text (cooperation material text) provided in a material providing service, and a text generated by a generative AI may be designatable. Moreover, a configuration may be such that these obtaining destinations are designated in the text designation component 202 to obtain the text group including multiple texts. Furthermore, the configuration may be such that designation of the text group is not limited to the title, and is similarly received also for the subtitle and the main text.

### <Poster Generation Process in Content Prioritized Mode>

Next, the poster generation process in the content prioritized mode is explained.

FIGS. 23A and 23B are flowcharts explaining the poster generation process in the content prioritized mode in detail. The present flowchart is executed in S1404 to which the process transitions in the case where the content prioritized mode is set in the operation mode switching process illustrated in FIG. 14. Note that, since processes similar to those in FIGS. 15A and 15B (poster generation process in the impression prioritized mode) are executed in steps of FIGS. 23A and 23B denoted by the same reference numerals as those in FIGS. 15A and 15B, explanation thereof is omitted. In the poster generation process in the content prioritized mode, S1502 (setting obtaining) and S1503 (image obtaining) in the poster generation process in the impression prioritized mode are omitted. Instead, S2301 (image obtaining), S2302 (image impression estimation), S2303 (changing of UI for setting target impression), and S2304 (setting obtaining) are added. Note that, in the content prioritized mode, the image impression estimation component 221 and the UI changing component 222 in FIG. 2 are used. Portions different from the impression prioritized mode are mainly explained below.

In S1501 of FIG. 23A, it is assumed that, on the generation condition setting screen 701, the image addition button 707 is pressed and the OK button 717 is pressed in a state where one or multiple images are designated by the user on the image designation screen 801.

In S2301, the image obtaining component 211 obtains the image data designated by the user. Specifically, the image obtaining component 211 reads out the one or multiple pieces of image data from the obtaining destination designated in the image designation component 203 to the RAM 103.

In S2302, the image impression estimation component 221 estimates the impression of each of the one or multiple pieces of image data obtained in S2301, and associates the estimated impression value with a corresponding piece of image data. The impression of the image data can be estimated by using the trained model generated by performing the impression quantification process of the content (image) illustrated in FIG. 9 as in S1607 described above.

In S2303, the UI changing component 222 changes the state of the UI for designating the target impression on the generation condition setting screen 701, based on the estimated impression of each of the one or multiple images obtained in S2302. For example, the UI changing component 222 changes the on/off setting of the radio button 712 corresponding to each impression factor depending on the impressions estimated from the images. In the present embodiment, in the case where the standard deviation of the estimated impressions of the images in a certain impression factor is equal to or larger than a predetermined threshold, that is in the case where distribution of the estimated impressions of the impression factor is wide, the radio button 712 of the impression factor is set to off. The radio buttons 712 of the other impression factors are set to on. This is due to the following reason. If images for which the distribution of the estimated impressions is wide are designated, there would be an image that is suitable regardless of what target impression the user designates, and this does not contribute to narrowing-down of images.

In S2304, the poster creation condition designation component 201, the text designation component 202, and the target impression designation component 204 each obtain a corresponding setting from the generation condition setting screen 701.

After S2304, the process proceeds to the content selection process of S1504. Processes of S1504 and beyond are the same as the processes explained in the impression prioritized mode. Moreover, although the example in which the UI changing component 222 changes the UI for setting the target impression based on the estimated impressions of the images is explained in the present flowchart, this process can be also similarly applied to texts. Specifically, the UI changing component 222 may change the UI for setting the target impression based on estimated impressions of texts designated by the user.

As explained above, in the poster generation process in the content prioritized mode, the UI for setting the target impression is changed depending on the impression of each of the one or multiple contents designated by the user, and the target impression designatable by the user is changed. Accordingly, designation of the target impression close to the impression of the content is facilitated. Moreover, in the case where the texts are designated or the creation conditions such as the poster size and the use application category are designated, the content selection component 220 selects contents close to the target impression, and a poster including the selected contents and matching the creation conditions is generated.

### Modified Example 1 of First Embodiment

Although the setting of the target impression is performed by using the impression sliders 708 to 711 of the generation condition setting screen 701 as the objects operated to set the target impression in the first embodiment, the setting method of the target impression is not limited to this.

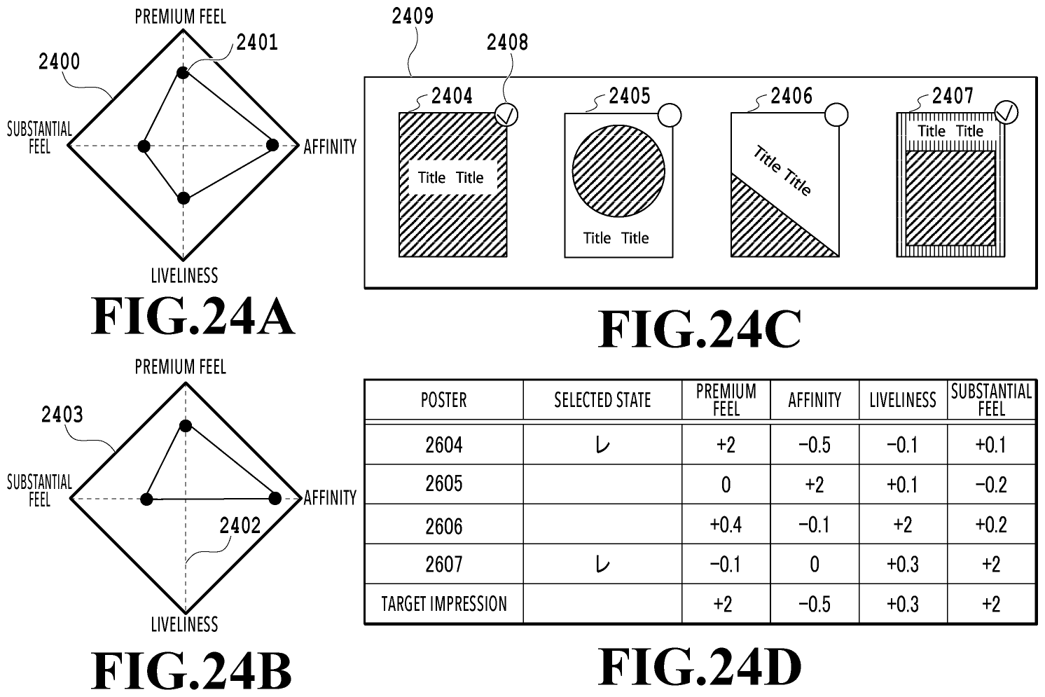

FIGS. 24A to 24D are diagrams illustrating examples of the UI for the setting of the target impression. FIG. 24A illustrates an example of setting the target impression by using a UI on a radar chart 2400. The target impression values of the respective impression factors set on the respective axes of the radar chart 2400 in FIG. 24A can be set by operating handles 2401 on the radar chart 2400. For example, the target impression designation component 204 obtains the target impression value for each axis such that the target impression value is −2 in the case where the handle 2401 is at the center in the UI, and is +2 in the case where the handle 2401 is at the outer-most position in the UI. In FIG. 24A, the target impression value is premium feel +0.8, affinity +1.1, liveliness −0.1, and substantial feel −0.7. As described above, the target impression value may include decimals. Moreover, the radar chart 2403 of FIG. 24B illustrates a state where one of the impression factors is set to off by the user or the UI changing component 222. For example, the user can double click the handle with the pointing device 107 to set the target impression value of the axis corresponding to this handle to off and hide the target impression value. Note that the user can click an axis 2402 on a radar chart 2403 with the pointing device 107 to set this target impression value to on and display this target impression value again. FIG. 24B is a state in which the target impression values of the impression factors other than liveliness are the same as those in FIG. 24A and liveliness is set to off.

Note that, in the content prioritized mode, the UI changing component 222 changes the operable impression factors (axes) also in the case where the target impression is set by using the UI on the radar chart, as in the UI on the sliders explained in the first embodiment. Specifically, as illustrated in the radar chart 2403, in the case where the standard deviation of the estimated impressions of the images in a certain impression factor is equal to or more than the predetermined threshold, that is in the case where the distribution of the estimated impressions in this impression factor is wide, the handle of the axis corresponding to this impression factor is set to off.

In this case, an axis in which the operation cannot be performed may be illustrated in a display form different from the operable axis, for example, illustrated in gray.

Moreover, the target impression designation component 204 may receive the designation of the target designation by designation of information representing an impression (hereinafter, referred to as representation information). FIG. 24C illustrates an example of a UI in which the target impression is set based on samples of poster images (hereinafter, referred to as sample poster images) that are the representation information, instead words such as “premium feel” and “affinity”. Sample poster images 2404 to 2407 in each of which one of impressions is great are arranged in a sample poster display region 2409. Moreover, a check box 2408 is displayed in each of the sample poster images. The user can click the sample poster image assumed to be close to the impression of the poster desired to be created with the pointing device 107 to turn on the check box 2408 and set the check box 2408 to a selected state. The target impression designation component 204 determines the target impression by referring to impression values corresponding to the sample poster image in the selected state.

FIG. 24D is a table illustrating the impression values corresponding to the sample poster images 2404 to 2407 in FIG. 24C and final target impression values. The columns of premium feel, affinity, liveliness, and substantial feel each illustrate a number indicating a level of an influence of each sample poster image on the corresponding impression factor. For example, assume that the sample poster images 2404 and 2407 are in the selected state as in FIG. 24C. In this case, the target impression designation component 204 determines impression values obtained by combining the impression values of the sample poster images 2404 and 2407, as the final target impression values. In this example, for each impression factor, the value with the larger absolute value out of the values corresponding to the selected sample poster images 2404 and 2407 is set as the final target impression value. Note that, although description is given of the example in which the poster images in each of which one of the impressions is the greatest are presented, the present disclosure is not limited to this. A sample poster image in which impression values of multiple impression factors are large may be used, or sample poster images more than the number of impression factors may be presented. The user can thereby intuitively designate the target impression based on actual images of creation products without using words.

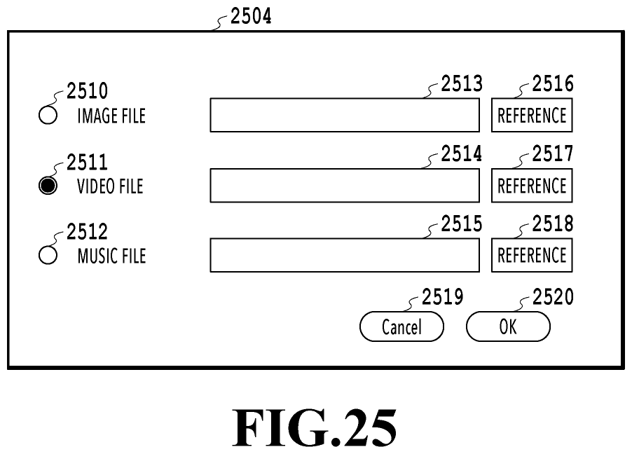

FIG. 25 is a diagram illustrating an example of a target impression setting screen 2504 in which the target impression is designated by using medium files such as an image file, a video file, and a music file as the representation information. The target impression setting screen 2504 is displayed on the display 105 by pressing a not-illustrated target impression setting button provided on the generation condition setting screen 701. Radio buttons 2510 to 2512 are each a button for selecting a type of the medium file to be used in the setting of the target impression. The user can set the type of the medium file by pressing one of the radio buttons 2510 to 2512 and setting on/off. Note that only one of the multiple radio buttons 2510 to 2512 can be set to on. Specifically, in the case where a radio button set off is set to on, this radio button is set to on, but the radio button set to on before the setting is automatically set to off.

The radio button 2510 is a button for setting an image file as the type of medium file. A designation box 2513 receives designation of the image file. The user can designate an image representing the target impression by designating a file path of the image in the designation box 2513. A reference button 2516 is a button for designating an obtaining destination of the image file. In the case where the user presses the reference button 2516, the poster creation application displays a dialog screen for selecting a file saved in the HDD 104, and receives image file selection by the user.

The radio button 2511 is a button for setting a video file as the type of medium file. A designation box 2514 receives designation of the video file. The user can designate a video representing the target impression by designating a file path of the video in the designation box 2514. A reference button 2517 is a button for designating an obtaining destination of the video file. In the case where the user presses the reference button 2517, the poster creation application displays a dialog screen for selecting a file saved in the HDD 104, and receives video file selection by the user.

The radio button 2512 is a button for setting a music file as the type of medium file. A designation box 2515 receives designation of the music file. The user can designate a music representing the target impression by designating a file path of the music in the designation box 2515. A reference button 2518 is a button for designating an obtaining destination of the music file. In the case where the user presses the reference button 2518, the poster creation application displays a dialog screen for selecting a file saved in the HDD 104, and receives music file selection by the user.

A cancel button 2519 is a button for cancelling the setting of the target impression on the target impression setting screen 2504 and returning to the generation condition setting screen 701. In the case where an OK button 2520 is pressed, the medium file associated with the radio button set to on is transmitted to a not-illustrated content impression estimation component. The content impression estimation component executes, for example, impression estimation using a machine learning model on the content (image, video, or music) of the medium file.

An impression estimation method for each medium file is explained. For the image, quantification of the impression and building of an estimation model can be performed by performing the content impression quantification process explained in FIG. 9A. For the video, CNN or ViT is executed with the image replaced with the video in the content impression quantification process explained in FIG. 9. Moreover, quantification of the impression and building of an estimation model can be also performed by using a deep learning method such as recurrent neural network (RNN), long short term memory (LSTM), or three-dimensional CNN. For the music, quantification of the impression and building of an estimation model can be performed by using a deep learning method such as RNN and LSTM with the image replaced with the music in the process explained in FIG. 9.

In the impression prioritized mode, the target impression designation component 204 obtains the impression estimated from the image, the video, or the music as the target impression. Then, the target impression is used in the selection of contents in the content selection component 220, the selection of skeletons in the skeleton selection component 214, the selection of color scheme patterns in the color scheme pattern selection component 215, and the selection of fonts in the font selection component 216. In the content prioritized mode, the impression estimated from the image, the video, or the music is obtained as the target impression, and in addition, the estimated impression is transmitted to the UI changing component 222. The UI changing component 222 reflects the impression estimated from the medium file, in the changing of the UI (for example, the impression sliders 708 to 711 on the generation condition setting screen 701) for setting the target impression.

Note that, in the content prioritized mode, in the UI (FIG. 24C) for setting the target impression based on the sample poster images, the UI changing component 222 may change the designatable sample poster images. Specifically, the UI changing component 222 selects sample poster images whose impression value for a specific impression factor is 0 or close to 0, from among the sample poster images with various impressions, and displays the selected sample poster images in the sample poster display region 2409. Alternatively, the UI changing component 222 limits the designatable sample poster images to the sample poster images having a specific impression value.

### Modified Example 2 of First Embodiment

Description is given of the example in which the content selection component 220 of the first embodiment selects the top N (N is an integer equal to or more than one) contents in ascending order of the value of the distance between the target impression designated by the user and the estimated impression of each content. However, the selection method of the contents is not limited to this. For example, the contents may be selected based on a similarity to representation information designated by the user in addition to the distance to the target impression. The representation information in this example is a text or an image representing the contents desired to be used by the user. For example, the representation information is assumed to be designatable by the user in a not-illustrated representation information input region in the generation condition setting screen 701. The content selection component 220 may determine the similarity between the representation information designated by the user and an image designated by the user or each of images included in an image group, and select the contents based on the similarity in addition to the distance to the target impression for this image. The similarity between the representation information and the image can be determined by using an image classification model such as CLIP. The content selection component 220 may select contents with high similarities with the representation information, among contents for which the distance between the target impression designated by the user and the estimated impression is small, as the contents to be used in the poster.

### Second Embodiment

In the first embodiment, explanation is given of the example in which, in the impression prioritized mode, the contents suiting the target impression designated by the user are selected from the content group, and the poster is generated based on the target impression designated by the user by using the selected contents. The poster creation application of a second embodiment generates multiple pieces of poster data in which the contents included in the content group are arranged, and selects the poster in which the impression of the poster image as a whole is close to the target impression, from among the generated posters. In the second embodiment, the poster creation application includes a combination generation component 2601 for generating multiple posters. The combination generation component 2601 generates combinations of contents and components (skeleton, font, color scheme) of the poster in which the impression of the poster as a whole is close to the target impression, based on a genetic algorithm. The poster creation application can thereby generate a poster while using contents that cause the impression of the poster as a whole to be close to the target impression, among the contents included in the content group. Specifically, contents that cause the impression of the poster as a whole to be suitable for the target impression are selected from the content group.

### <Software Block Diagram>

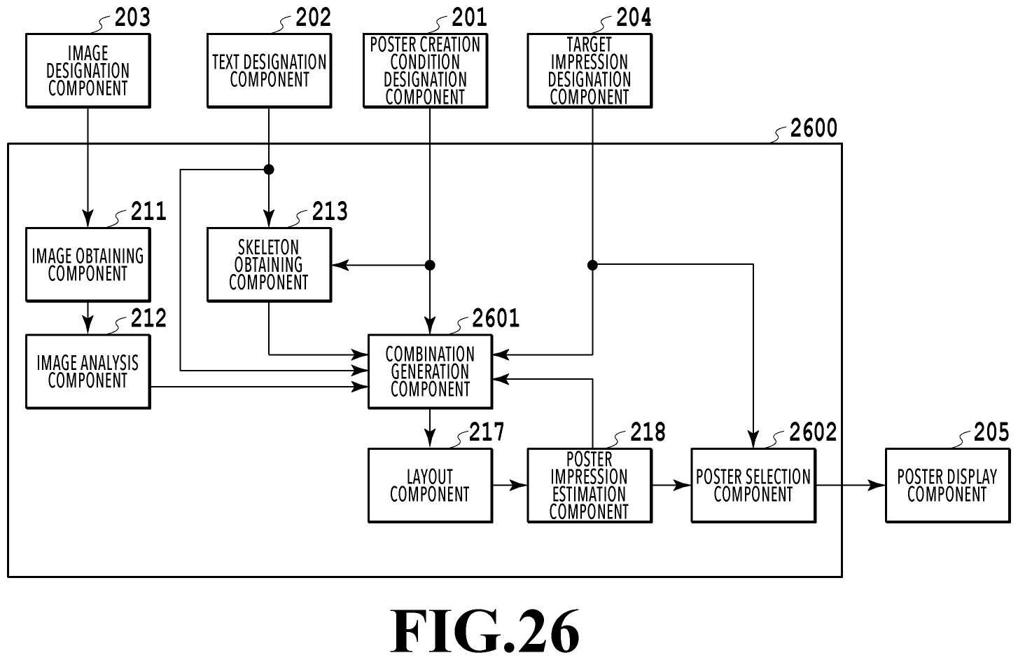

FIG. 26 is a software block diagram in the case where the impression prioritized mode is set in the poster creation application of the second embodiment. As illustrated in FIG. 26, the poster creation application includes the poster creation condition designation component 201, the text designation component 202, the image designation component 203, the target impression designation component 204, the poster display component 205, and a poster generation component 2600. The poster generation component 2600 includes the image obtaining component 211, the image analysis component 212, the skeleton obtaining component 213, the layout component 217, the poster impression estimation component 218, a poster selection component 2602, and the combination generation component 2601. In FIG. 2, the operation mode designation component 230 is omitted.

The poster generation component 2600 is different from the poster generation component 210 of the first embodiment in that the poster generation component 2600 includes the combination generation component 2601 instead of the skeleton selection component 214, the color scheme pattern selection component 215, the font selection component 216, and the content selection component 220 in FIG. 2. Moreover, the poster selection component 2602 performs a process different from the poster selection component 219 of the first embodiment. Since the configurations in FIG. 26 denoted by the same reference numerals as those in FIG. 2 are the same as those in the first embodiment, explanation thereof is omitted.

The combination generation component 2601 obtains one or multiple skeletons from the skeleton obtaining component 213, obtains the poster data and the poster estimated impression from the poster impression estimation component 218, and obtains the target impression from the target impression designation component 204. Moreover, the combination generation component 2601 obtains lists of the color scheme patterns and the fonts from the HDD 104. Furthermore, the combination generation component 2601 obtains the image number from the poster creation condition designation component 201, obtains the image data from the image analysis component 212, and obtains the title character information of from the text designation component 202. The combination generation component 2601 generates combinations of the poster components (skeletons, color scheme patterns, fonts, images, titles) to be used in the poster generation. The combination generation component 2601 outputs the generated combinations of the poster components to the layout component 217. The generation of the combinations is described later.

The poster selection component 2602 selects posters in each of which the distance between the estimated impression of the poster and the target impression designated in the target impression designation component 204 is equal to or smaller than the threshold, from among multiple posters generated from the multiple combinations generated by the combination generation component 2601, and saves the selected posters in the RAM 103. Moreover, the poster selection component 2602 determines whether the number of selected and saved posters has reached the creation number designated in the creation number box 714 of FIG. 7, and repeats the generation of the combinations and the poster selection until the number of selected and saved posters reaches the creation number. The poster selection component 219 outputs the selected poster data to the poster display component 205.

### <Poster Generation Process in Impression Prioritized Mode>

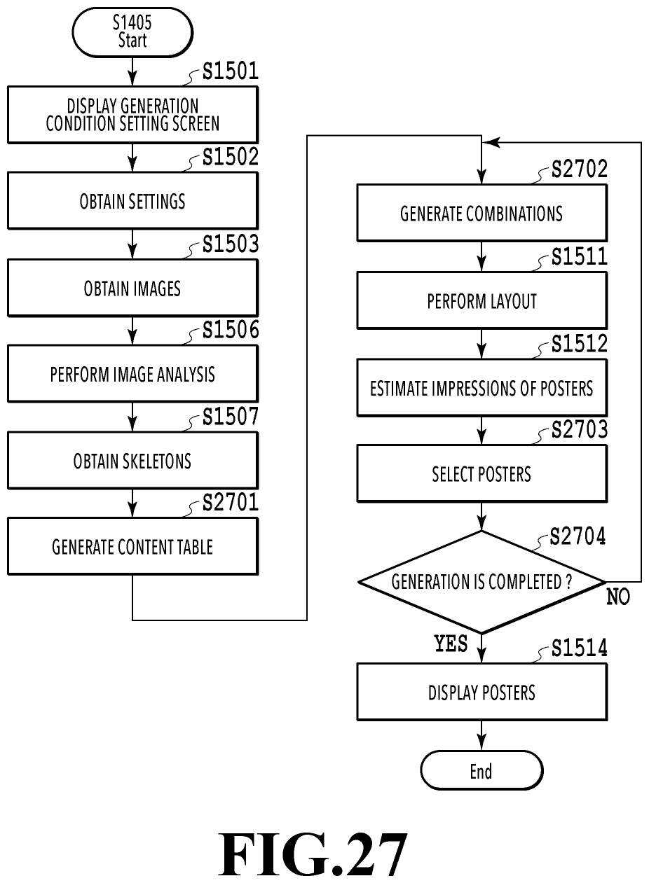

FIG. 27 is a flowchart illustrating the poster generation process executed in the case where the impression prioritized mode is set in the poster creation application of the second embodiment. The process illustrated in the present flowchart is started in the case where the impression prioritized mode is selected (S1405; YES) in the operation mode switching process (FIG. 14). Note that, since the processes in FIG. 27 denoted by the same reference numerals as those in FIGS. 15A and 15B (poster generation process in the impression prioritized mode of the first embodiment) are the same as those in the first embodiment, explanation thereof is omitted. Moreover, in the poster generation process in the impression prioritized mode of the second embodiment illustrated in the present flowchart, S1504 (content selection process) and S1505 (selection number determination) illustrated in FIG. 15A are omitted. Furthermore, S1508 to S1510 (skeleton selection, color scheme pattern selection, and font selection) are omitted, and S2701 (content table generation) and S2702 (combination generation) are added after the skeleton obtaining in S1507. Moreover, S2703 (poster selection) and S2704 (determination of generation termination) are added instead of S1513 (poster selection). Points different from the first embodiment are mainly explained below.

In S1501 to S1507, on the generation condition setting screen 701, the target impression, the text, and the image are designated, and the creation conditions (size, creation number, image number, and use application category) of the poster are designated. The image obtaining component 211 obtains the designated image data, and the image analysis component 212 analyzes the image data to obtain the feature amounts of the images. Moreover, the skeleton obtaining component 213 obtains the skeletons matching the various setting conditions from the HDD 104.

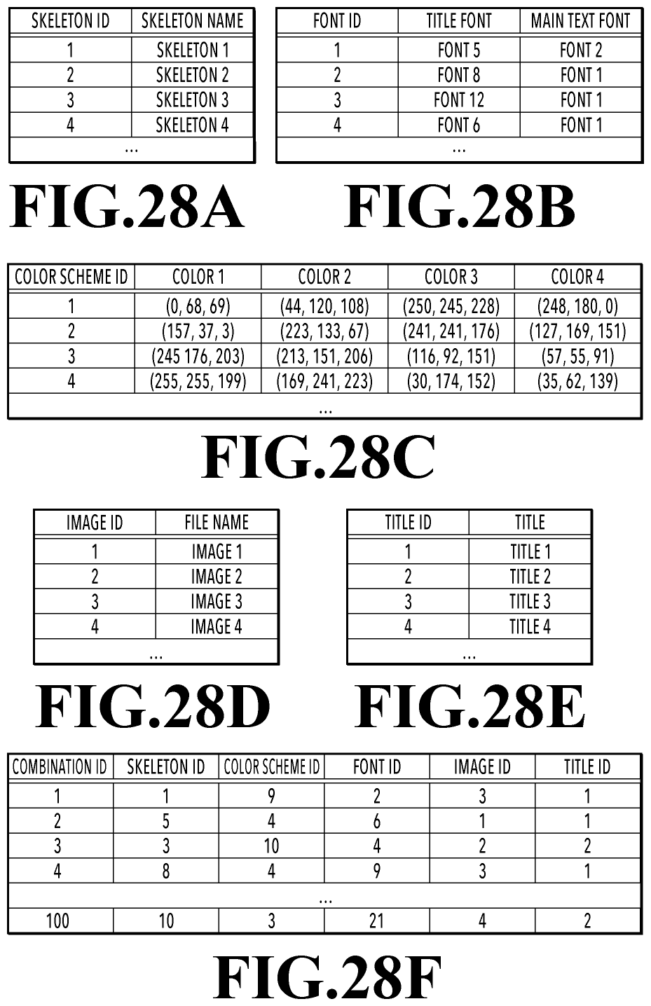

In S2701, the combination generation component 2601 generates a table relating to each of the contents (images and titles) to be used in the poster generation. FIG. 28A illustrates a list of skeletons obtained from the skeleton obtaining component 213 by the combination generation component 2601. FIGS. 28B and 28C illustrate the list of fonts and the list of color schemes obtained from the HDD 104 by the combination generation component 2601, respectively. FIG. 28D illustrates a list of image data obtained from the image analysis component 212 by the combination generation component 2601. The combination generation component 2601 generates a list of image data obtained from the image analysis component 212. Moreover, FIG. 28E illustrates a list of title character information obtained from the text designation component 202 by the combination generation component 2601. The combination generation component 2601 generates the list of title character information obtained from the text designation component 202.

### <Combination Generation Process>

The processes of S2702, S1511, S1512, S2703, and S2704 are repeated processes. The processes of S2702 to S2704 are explained with an operation in initial execution and an operation in the second loop and beyond separately explained.

In initial execution of S2702, the combination generation component 2601 obtains the tables of skeletons, color schemes, and fonts that are illustrated in FIGS. 28A to 28C and that are to be used in the poster generation. The combination generation component 2601 generates random combinations from fives tables that are the table of images (FIG. 28D) and the table of titles (FIG. 28E) generated in S2701 as well as the three tables described above. In the present embodiment, 100 combinations are assumed to be generated. FIG. 28F illustrates a combination table generated in the present embodiment.

The combination generation component 2601 executes the processes of layout (S1511), poster impression estimation (S1512), and poster selection (S2703) for all of the generated combinations. The poster impression estimation is performed by causing the CPU 101 and the GPU 109 to operate the deep learning model for poster impression estimation expanded on the RAM 103 as in the first embodiment. Note that the present disclosure is not limited to deep learning. For example, in the case where a machine learning method such as a decision tree is to be used, there may be created a machine learning model that extracts feature amounts such as a brightness average value, an edge amount, and the like of each poster image by performing image analysis and that estimates the impression based on these feature amounts.

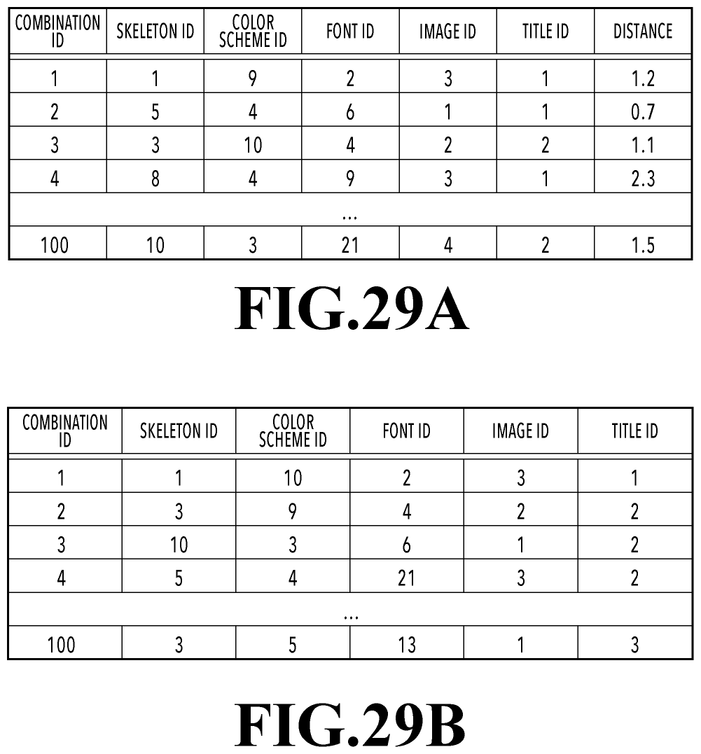

In S2702 of the second loop and beyond, the combination generation component 2601 determines the distance between the target impression and each of the poster estimated impressions obtained from the poster impression estimation component 218, and associates the determined distance with a corresponding one of the combination in the combination table. FIGS. 29A and 29B are diagrams explaining the operation of S2702 in the second loop and beyond. FIG. 29A is a table in which the value of the distance between the target impression and each poster estimated impression is associated with the corresponding combination in the combination table illustrated in FIG. 28F. Specifically, the layout component 217 generates a poster based on each combination in the combination table illustrated in FIG. 28F, and the poster impression estimation component 218 estimates the impression of each of the generated posters. Each of values illustrated in the column of “distance” in FIG. 29A is a value indicating the distance between the target impression and the estimated impression of the poster generated in the combination of the corresponding row.

The combination generation component 2601 generates a new combination table, based on the results illustrated in FIG. 29A. FIG. 29B is the newly-generated combination table. In the second embodiment, new combinations are assumed to be generated by using tournament selection and uniform crossover in a genetic algorithm. The combination generation component 2601 first randomly selects N combinations from the table of FIG. 29A. In this case, for example, N=3. Next, top two combinations in ascending order of the distance (=close to target impression) are selected from among the selected combinations. Lastly, new combinations are generated by randomly replacing the combination elements (skeleton ID, color scheme ID, font ID, image ID, and title ID) in the two selected combinations. For example, the combination IDs 1 and 2 in FIG. 29B illustrate results generated from the combination IDs 1 and 3 in FIG. 29A, and the numbers of the color scheme IDs are interchanged in the example illustrated in FIG. 29B. FIG. 29B illustrates 100 new combinations generated by repeating the above-mentioned procedure.

Searching of the combinations can be thereby efficiently performed based on the value of the distance between the target impression and the poster estimated impression. Note that, although 100 combinations are generated in the present embodiment, the number of combinations to be generated is not limited to this. Moreover, although the tournament selection and the uniform crossover are used, the present disclosure is not limited to this, and other methods such as, for example, ranking selection, roulette selection, and one-point crossover may be used. Furthermore, mutation may be incorporated to make the combination generation less likely to fall into local optimal solution. Moreover, although the skeleton (arrangement), the color scheme pattern, the font, the image, and the title are used as the components of the posters to be searched for, other components may be used. For example, the configuration may be such that multiple patterns to be inserted into a background of the poster are prepared, and which pattern is to be used or which pattern is not to be used is determined by searching. Increasing the components to be searched for enables generation of posters of greater variation, and can increase a range of impression representation.

In S2703, the poster selection component 2602 determines the value of the distance between the target impression and each poster estimated impression as in S2702, for the new combination table. Moreover, a table in which the value of the distance between the target impression and the poster estimated impression is associated is created for the new combination table as in FIG. 29A. The poster selection component 2602 saves the poster images for which the value of the distance to the target impression is equal to or less than the threshold, in the RAM 103.

In S2704, the poster selection component 2602 determines whether the number of poster images saved in the RAM 103 in S2703 has reached the creation number designated in the creation number box 714 in FIG. 7. In the case where the poster selection component 2602 determines that the number of poster images has reached the creation number, the process proceeds to S1514. In the case where the poster selection component 2602 determines that the number of poster images has not reached the creation number, the process returns to S2702. Specifically, the process of S2702 in the second loop described above is executed, and the processes of S2702, S1511, S1512, and S2703 are repeatedly executed until the number of poster images for which the value of the distance between the target impression and the poster estimated impression is equal to or less than the threshold reaches the designated creation number.

In the case where the number of poster images for which the value of the distance between the target impression and the poster estimated impression is equal to or less than the threshold is equal to or more than the designated creation number, the poster selection component 2602 compares the values of the distances of the respective poster images. Then, the poster image with a smaller value, that is the poster image closer to the target impression may be saved in the RAM 103. Moreover, in the case where the value of the distance of the poster image once saved in the RAM 103 is larger than that of the poster image selected after the saving, the poster selection component 2602 may delete the poster image saved in the RAM 103 from the RAM 103. Then, the poster selection component 2602 may save the poster image selected after the saving in the RAM 103 in place of the deleted poster image.

Note that, although the searching of the combinations of the poster components is performed by the genetic algorithm in the present embodiment, the searching method is not limited to this, and other searching methods such as the neighborhood searching method and the tabu searching method may be used.

As explained above, the poster creation application of the second embodiment receives the designation of the target impression by the user. Moreover, the poster creation application automatically generates the combinations of the contents (image and title), the skeleton, the font, and the color scheme to be used in the poster. Specifically, the poster creation application generates multiple pieces of poster data by combining the contents included in the content group and the components of the poster. Moreover, the poster selection component 2602 selects the combinations in which the impression of the poster as a whole is close to the target impression. A poster can be thereby generated by using contents by which the impression of the poster as a whole becomes close to the target impression designated by the user. In other words, a poster generated by the poster creation application in the case where designation of a first target impression is received is different from a poster generated by the poster creation application in the case where designation of a second target impression different from the first target impression is received. Moreover, the contents used in these posters are not necessarily the same, and different contents may be used. Accordingly, the contents selected based on the first target impression and included in the poster may be different from the contents selected based on the second target impression and included in the poster. The user can select a poster with a desired design from among the posters selected by the poster creation application, and output the selected poster. Accordingly, in the poster creation application of the second embodiment, obtaining of a creation product with an intended design is facilitated also for a user who does not have a clear idea of contents desired to be used.

### Third Embodiment

In the first embodiment, explanation is given of the example in which, in the impression prioritized mode, the poster creation application selects the contents suiting the target impression designated by the user, from the content group based on the target impression, and generates the poster. Moreover, in the second embodiment, the poster creation application creates many various combinations of the contents to be candidates, and selects a poster in which the impression of the poster as a whole is close to the target impression, from among the created combinations. A poster including the contents suiting the target impression designated by the user is thereby generated. In these examples, the contents suiting the target impression are automatically selected by the poster creation application from the content group including multiple contents to be candidates. Accordingly, there is a possibility that the content desired to be used by the user is not used in the final poster.

Accordingly, in a third embodiment, the poster creation application first selects multiple contents suiting the target impression designated by the user, from the content group based on the target impression, and sets the selected contents as the candidates of contents, as in the first and second embodiments. Then, the poster creation application presents the selected candidates of contents to the user, and receives designation, by the user, of the contents to be actually used. The poster creation application can thereby present the content candidates suiting the target impression in a state where the candidates are narrowed down from the content group, and generate the poster while certainly using the desired content selected by the user from the content candidates.

### <Software Block Diagram>

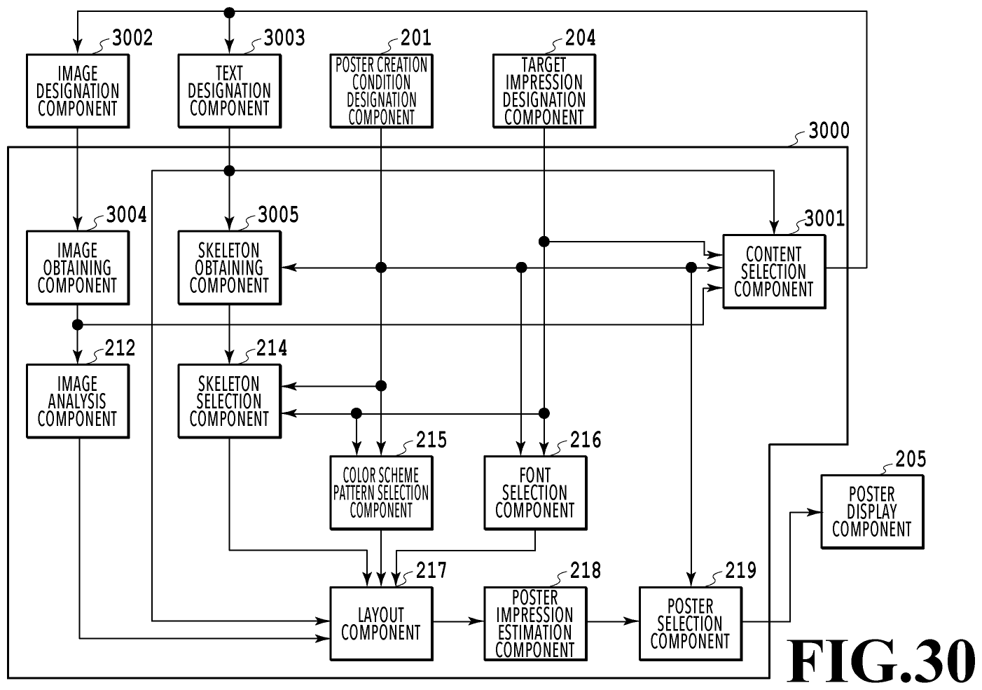

FIG. 30 is a software block diagram in the case where the impression prioritized mode is set in the poster creation application of the third embodiment. As illustrated in FIG. 30, the poster creation application includes the poster creation condition designation component 201, a text designation component 3003, an image designation component 3002, the target impression designation component 204, the poster display component 205, and a poster generation component 3000. The poster generation component 3000 of the third embodiment includes an image obtaining component 3004, the image analysis component 212, a skeleton obtaining component 3005, the skeleton selection component 214, the color scheme pattern selection component 215, the font selection component 216, the layout component 217, the poster impression estimation component 218, the poster selection component 219, and a content selection component 3001. Since the configurations in FIG. 30 denoted by the same reference numerals as those in FIG. 2 are the same as the configurations in the first embodiment, explanation thereof is omitted. Moreover, the operation mode designation component 230 is omitted.

The content selection component 3001 obtains the image number from the poster creation condition designation component 201. Moreover, the content selection component 3001 obtains one or multiple pieces of character information to be candidates from the text designation component 3003. Furthermore, the content selection component 3001 obtains one or multiple pieces of image data (image group) to be candidates from the image obtaining component 3004. Moreover, the content selection component 3001 obtains the designated target impression from the target impression designation component 204. Then, the content selection component 3001 selects candidates of image data to be used in the poster from the image group, based on the target impression and the image number. Moreover, the content selection component 3001 selects candidates of character information to be used in the poster, from the character information to be candidates, based on the target impression. The content selection component 3001 outputs the selected candidates of image data to the image designation component 3002, and outputs the selected candidates of character information to the text designation component 3003.

The image designation component 3002 receives designation, by the user, of the image data to be used in the poster from among the candidates of image data selected in the content selection component 3001, while additionally performing the process explained in the image designation component 203 of the first embodiment. The image designation component 3002 outputs the file path of the designated image to the image obtaining component 3004.

The text designation component 3003 receives designation, by the user, of the character information to be used in the poster from among the candidates of character information selected in the content selection component 3001 while additionally performing the process explained in the text designation component 202 of the first embodiment. The text designation component 3003 associates each piece of character information with information indicating which one of title, time and date, location, and the like the type of the character information is to allow determination of the type of the character information, and then outputs the character information to the skeleton obtaining component 3005 and the layout component 217.

The image obtaining component 3004 outputs the image data to be used in the poster, designated by the user in the image designation component 3002 from among the selected candidates of image data, to the image analysis component 212 while additionally performing the process explained in the image obtaining component 211 of the first embodiment.

The skeleton obtaining component 3005 obtains one or multiple skeletons matching the conditions designated in the poster creation condition designation component 201 and the text designation component 3003, from the HDD 104. The skeleton obtaining component 3005 outputs the one or multiple skeletons obtained from the HDD 104, to the skeleton selection component 214.

### Example of Display Screen

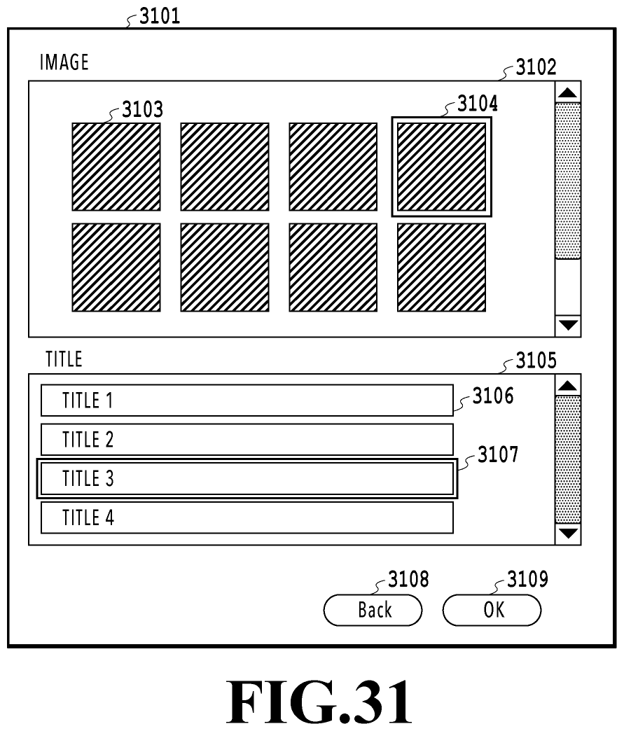

FIG. 31 is a diagram illustrating an example of a content designation screen 3101 provided by the poster creation application. The content designation screen 3101 is displayed on the display 105 after the OK button 717 of the generation condition setting screen 701 illustrated in FIG. 7 is pressed and a process of the content selection component 3001 to be described later is performed. The user designates the image and the title to be used in the poster through the content designation screen 3101, and the image designation component 3002 and the text designation component 3003 obtain the setting contents from the user through this UI screen.

An image designation region 3102 is a region in which the candidates of image to be used in the poster are displayed. Images 3103 illustrate thumbnails of the images selected by the content selection component 3001. The user can select any of the images 3103 by performing a click operation with the pointing device 107. FIG. 31 illustrates that an image surrounded by a selection frame 3104 is in a state where the image is selected by the user. The selection frame 3104 is displayed for the thumbnail selected by the user, and in the case where the user selects the same thumbnail again in this state, the selection frame 3104 disappears and the selected state is cancelled. Note that multiple images 3103 to be used in the poster can be selected.

A title designation region 3105 is a region in which the candidates of title to be used in the poster are displayed. The titles selected by the content selection component 3001 are displayed in title boxes 3106. The user can select any of the title boxes 3106 by performing a click operation with the pointing device 107. FIG. 31 illustrates that a title box surrounded by a selection frame 3107 is in a state where the title box is selected by the user. The selection frame 3107 is displayed for the title box selected by the user, and in the case where the user selects the same title box again in this state, the selection frame 3107 disappears and the selected state is cancelled. As described above, the candidates of contents (multiple images and multiple pieces of character information) selected by the content selection component 3001 are displayed on the content designation screen 3101 to be selectable.

A back button 3108 is a button for cancelling the contents designated on the content designation screen 3101 and returning to the generation condition setting screen 701. In the case where the back button 3108 is pressed, the pieces of setting information on the content designation screen 3101 are ignored, and the screen displayed on the display 105 transitions to the generation condition setting screen 701.

In the case where the user presses an OK button 3109, the image designation component 3002 and the text designation component 3003 outputs the contents designated on the content designation screen 3101 to the poster generation component 3000. The image designation component 3002 obtains the file path of the image selected in the image designation region 3102. The text designation component 3003 obtains the title character information selected in the title designation region 3105. Note that, in the case where the number of images designated in the image designation region 3102 does not match the number designated in the image number box 720 of the generation condition setting screen 701, the image designation component 3002 displays a dialog screen reporting mismatch of the numbers. Then, the image designation component 3002 displays the content designation screen 3101 again, and prompts the user to reselect the image. Moreover, in the case where the number of titles designated in the title designation region 3105 is more than one, the text designation component 3003 displays a dialog screen reporting that the number of titles is too many. Then, the title designation region 3105 displays the content designation screen 3101 again, and prompts the user to reselect the title.

### <Poster Generation Process>

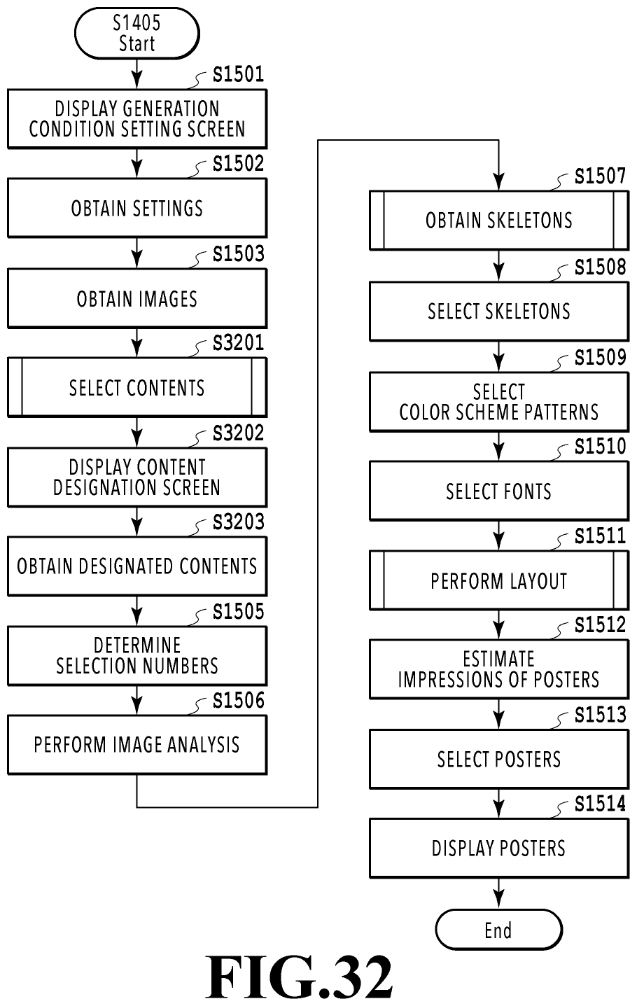

FIG. 32 is a flowchart illustrating the poster generation process executed in the case where the impression prioritized mode is set in the poster creation application of the third embodiment. The process illustrated in the present flowchart is started in the case where the impression prioritized mode is selected (S1405; YES) in the operation mode switching process (FIG. 14). Note that, since the processes in FIG. 32 denoted by the same reference numerals as those in FIGS. 15A and 15B (poster generation process in the impression prioritized mode of the first embodiment) are the same as those in the first embodiment, explanation thereof is omitted. Moreover, in the poster generation process in the impression prioritized mode of the third embodiment illustrated in the present flowchart, S3201 to S3203 are executed instead of S1504 illustrated in FIG. 15A. Points different from the first embodiment are mainly explained below.

In S1501 to S1507, on the generation condition setting screen 701, the target impression, the candidates of text, and the image group are designated, and the creation conditions (size, creation number, image number, and use application category) of the poster are designated. The image obtaining component 3004 obtains the image data of the designated image group, and the image analysis component 212 analyzes the image data to obtain the feature amounts of the images. Moreover, the skeleton obtaining component 213 obtains the skeletons matching the various setting conditions, from the HDD 104. Note that an image group including multiple images such as an image folder or an entire set of material images is assumed to be selected as the images, and a text group including multiple texts is assumed to be designated as the text. Furthermore, in the present embodiment, explanation is given by using the title character information as an example of the text.

In S3201, the content selection component 3001 selects multiple pieces of image data to be the candidates of image to be used in the poster, from the image group obtained in S1503. Moreover, the content selection component 3001 selects multiple pieces of character information to be the candidates of title to be used in the poster, from among the multiple pieces of title character information obtained in S1502.

### <Content Selection Process>

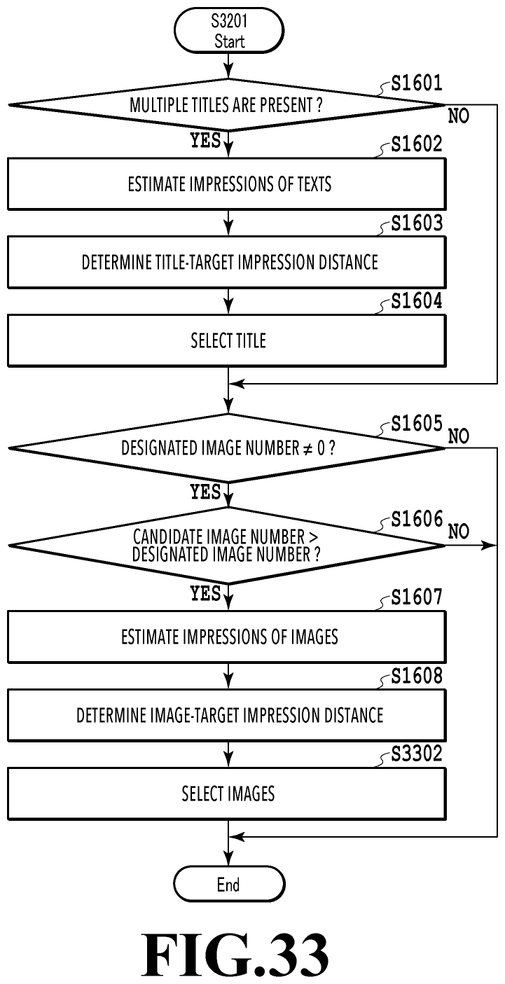

The content selection process executed in S3201 is explained in detail with reference to FIG. 33. FIG. 33 is a flowchart explaining S3201 in detail, and is executed by the content selection component 3001 of the third embodiment. Note that, since the processes in the flowchart of FIG. 33 denoted by the same reference numerals as those in FIG. 16 are the same as those in the content selection process of the first embodiment, explanation thereof is omitted.

In S3301, the content selection component 3001 selects top N titles in ascending order of the value of the distance between the target impression and the estimated impression of each of the titles to be candidates determined in S1603. In this case, the selection number N needs to be a value equal to or more than the number of titles to be used in the poster. In the present embodiment, since the number of titles to be used in the poster is one, the selection number N of the titles may be a number equal to or more than one. As an example, the content selection component 3001 is assumed to select top four titles. Note that, in the case where the number of titles designated in the generation condition setting screen 701 in S1501 is less than four, the selection number may be less than four. The content selection component 3001 is different from the content selection component 220 of the first embodiment in the following point. While the number of titles to be selected is one and is the same as the number of titles to be used in the poster in the first embodiment, titles as many as or more than the number of titles to be used in the poster are selected as the candidates in the third embodiment.

Note that the setting method of the selection number N may be a fixed value or reception of designation by the user. For example, a configuration may be such that a box (not illustrated) for designating the number (candidate number) of titles to be candidates is provided on the generation condition setting screen 701, and the process is performed with the designated candidate number set as the selection number N of the titles in S3301.

In S3302, the content selection component 3001 selects top N pieces of image data in ascending order of the value of the distance between the target impression and the estimated impression of each of the pieces of image data to be candidates determined in S1608. In this case, the selection number N needs to be a value equal to or more than the number of images to be used in the poster. In the present embodiment, as an example, the content selection component 3001 is assumed to select pieces of image data twice as many as the image number designated in the poster creation condition designation component 201. Note that the setting method of the selection number N of the images is not limited to this, and the selection number N may be any number as long as it is equal to or more than the number of images to be used in the poster. The content selection component 3001 is different from the content selection component 220 of the first embodiment in the following point. While the number of pieces of image data to be selected is the same as the image number designated in the poster creation condition designation component 201 in the first embodiment, pieces of image data as many as or more than the designated image number are selected as the candidates in the third embodiment.

The content selection process illustrated in FIG. 33 achieves a state where multiple titles close to the target impression in the title group designated by the user on the generation condition setting screen 701 are selected. Moreover, the content selection process achieves a state where multiple pieces of image data close to the target impression in the image group designated by the user on the generation condition setting screen 701 (image designation screen 801) are selected.

Returning to the explanation of FIG. 32, in S3202, the poster creation application obtains the contents (multiple titles, multiple pieces of image data) selected in S3201. Then, the poster creation application displays the content designation screen 3101 on which these multiple titles and these multiple pieces of image data are displayed as the candidates, on the display 105. The user inputs various settings with the keyboard 106 and the pointing device 107 through the UI screen of the content designation screen 3101.

In S3203, the image designation component 3002 obtains the image data designated by the user on the content designation screen 3101. Moreover, the text designation component 3003 obtains the title character information designated by the user on the content designation screen 3101. Then, the processes of S1505 and beyond are executed as in the first embodiment.

As explained above, the poster creation application of the third embodiment obtains the content groups designated by the user, selects multiple contents suiting the target impression from the content groups as the candidates, and displays the candidates of contents on the content designation screen 3101. Moreover, the poster creation application receives designation of the contents to be used in the poster from the user, on the content designation screen 3101. The user can thereby designate desired contents from multiple content candidates suiting the target impression. Moreover, a poster certainly using the contents designated by the user can be obtained.

Accordingly, for a user who does not have a clear idea of contents desired to be used, the poster creation application selects multiple content candidates, and the user can select the contents desired to be used from the selected multiple content candidates. Accordingly, obtaining of a creation product with an intended design is facilitated.

### Fourth Embodiment

In the first and second embodiments, explanation is given of an example in which the poster creation application selects the content to be used in the poster from the content group based on the target impression designated by the user, and generates the poster. Moreover, in the third embodiment, description is given of the example in which the poster creation application selects multiple candidates of the contents to be used in the poster from the content groups designated by the user, based on the target impression designated by the user, and presents the multiple candidates. Moreover, explanation is given of the example in which the user is made to designate the contents to be actually used from the presented candidates of the contents, and then the poster is generated.

In a fourth embodiment, in the impression prioritized mode, in the case where the poster creation application obtains the image data from the image group based on the target impression designated by the user, images suiting the target impression are extracted in advance to limit the images designatable by the user depending on the target impression. Moreover, explanation is given of an example in which the poster creation application receives input of the title (character information) by the user, and displays whether the title inputted by the user suites the target impression or not, based on the target impression designated by the user. The user can thereby designate an image desired to be used from among candidates of image suiting the target impression, only by designating the target impression. Moreover, the user can know whether the title suits the target impression or not in the inputting of the title. A poster suiting the target impression can be more efficiently generated.

### <Software Block Diagram>

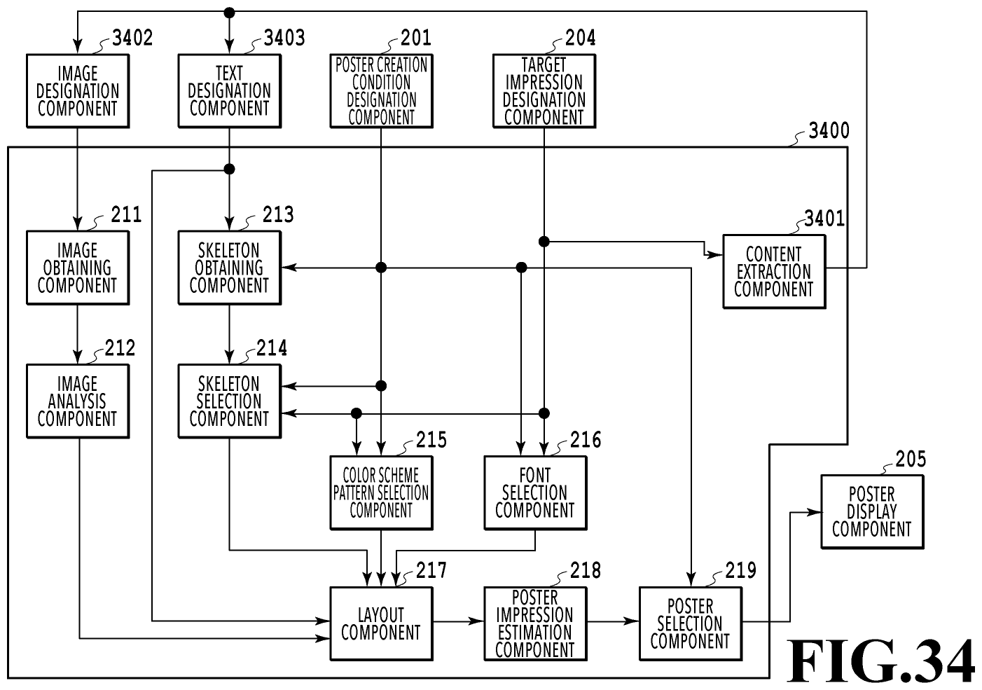

FIG. 34 is a software block diagram in the case where the impression prioritized mode is set in the poster creation application of the fourth embodiment. As illustrated in FIG. 34, the poster creation application includes the poster creation condition designation component 201, a text designation component 3403, an image designation component 3402, the target impression designation component 204, the poster display component 205, and a poster generation component 3400. The poster generation component 3400 includes the image obtaining component 211, the image analysis component 212, the skeleton obtaining component 213, the skeleton selection component 214, the color scheme pattern selection component 215, the font selection component 216, the layout component 217, the poster impression estimation component 218, the poster selection component 219, and a content extraction component 3401. Since the configurations in FIG. 34 denoted by the same reference numerals as those in FIG. 2 are the same as the configurations in the first embodiment, explanation thereof is omitted. Moreover, the operation mode designation component 230 is omitted.

In the case where the content extraction component 3401 obtains the image group designated by the user in the image designation component 3402, the content extraction component 3401 obtains the image group with images extracted from the image group based on the target impression obtained from the target impression designation component 204. This achieves a state where the images designatable by the user in the image designation component 3402 are narrowed down based on the target impression. Moreover, the content extraction component 3401 presents, to the user, whether the title inputted by the user in a title designation process executed by the text designation component 3403 suits the target impression or not, based on the target impression obtained from the target impression designation component 204. Determination of the images by the content extraction component 3401 and the title designation process are described later.

The image designation component 3402 presents the images determined in the content extraction component 3401 to the user as candidates of the image to be used in the poster, and receives designation, by the user, of an image from among the candidates of image. The image designation component 3402 outputs a file path of the image designated by the user to the image obtaining component 211.

The text designation component 3403 receives designation of the character information to be used in the poster from the user. In this case, the text designation component 3403 presents, to the user, whether the title inputted by the user suites the target impression or not. The text designation component 3403 outputs the character information designated by the user to the skeleton obtaining component 213 and the layout component 217.

### Example of Display Screen

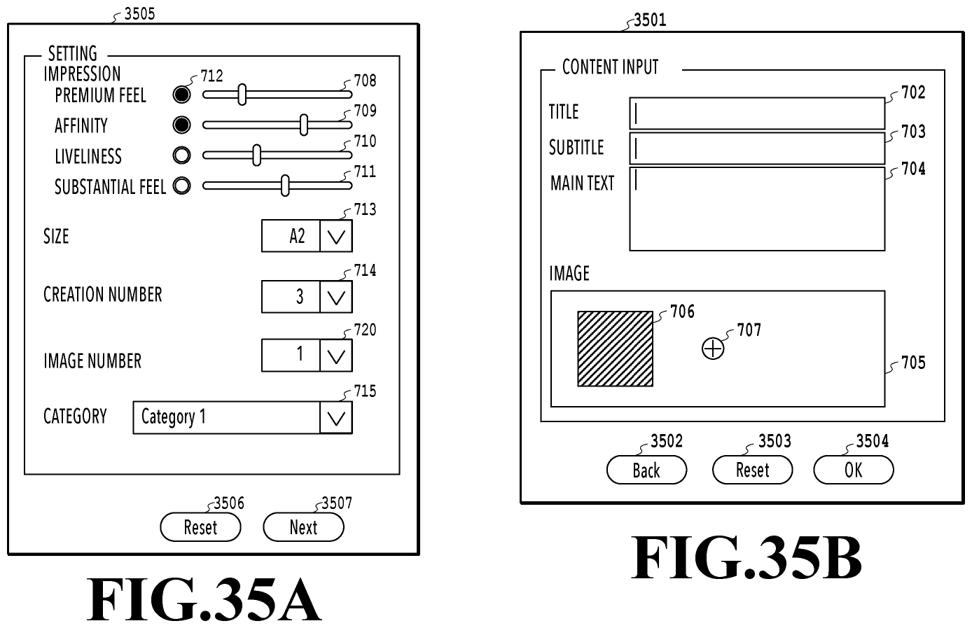

FIG. 35A illustrates an example of a generation condition setting screen 3505 in the fourth embodiment, and FIG. 35B is a diagram illustrating an example of a content setting screen 3501 in the fourth embodiment. The generation condition setting screen 3505 and the content setting screen 3501 are displayed on the display 105. The user designates the target impression and the creation conditions of the poster to be described later through the generation condition setting screen 3505. Moreover, the user designates the text and the image to be used in the poster through the content setting screen 3501. The poster creation condition designation component 201, the image designation component 3402, and the text designation component 3403 obtain setting contents from the user through these UI screens. Since the configurations in FIGS. 35A and 35B denoted by the same reference numerals as those in FIG. 7 are the same as the configurations in the first embodiment, explanation thereof is omitted.

A reset button 3506 on the generation condition setting screen 3505 is a button for resetting information set on the generation condition setting screen 3505. In the case where the user presses a next button 3507, the poster creation condition designation component 201 and the target impression designation component 204 output the setting contents set on the generation condition setting screen 3505 to the poster generation component 3400.

A back button 3502 of the content setting screen 3501 is a button for returning to the generation condition setting screen 3505. A reset button 3503 is a button for resetting pieces of setting information on the content setting screen 3501. In the case where the user presses an OK button 3504, the text designation component 3403 and the image designation component 3402 output the contents set on the content setting screen 3501 to the poster generation component 3400.

### <Poster Generation Process>

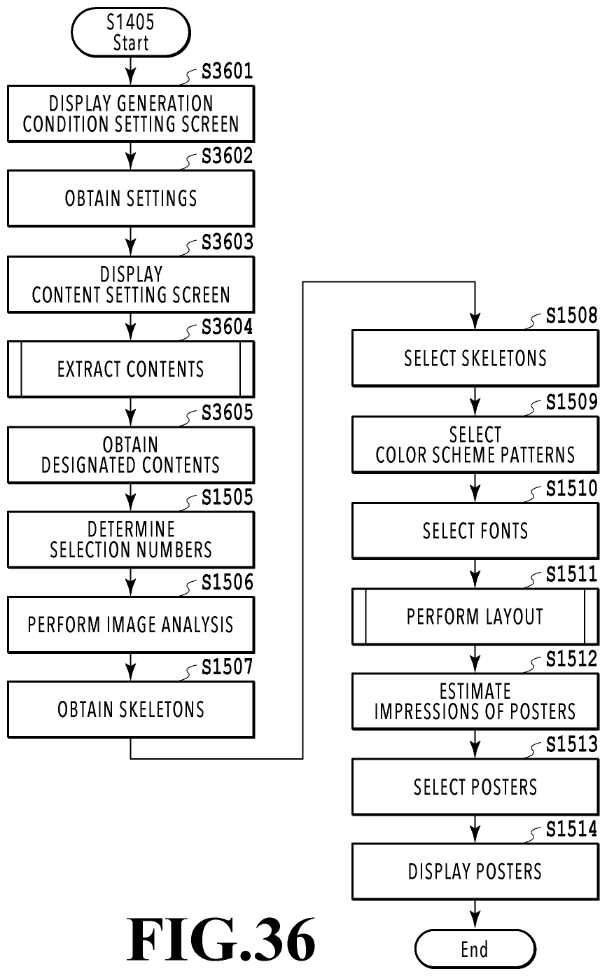

FIG. 36 is a flowchart illustrating the poster generation process executed in the case where the impression prioritized mode is set in the poster creation application of the fourth embodiment. The process illustrated in the present flowchart is started in the case where the impression prioritized mode is selected (S1405; YES) in the operation mode switching process (FIG. 14). Note that, since the processes in FIG. 36 denoted by the same reference numerals as those in FIGS. 15A and 15B (poster generation process in the impression prioritized mode of the first embodiment) are the same as those in the first embodiment, explanation thereof is omitted. In the poster generation process in the impression prioritized mode of the fourth embodiment illustrated in the present flowchart, S3601 to S3605 are executed instead of S1501 to S1505 illustrated in FIG. 15A. Points different from the first embodiment are mainly explained below.

In S3601, the poster creation application first displays the generation condition setting screen 3505 illustrated in FIG. 35A, on the display 105. The user inputs various settings with the keyboard 106 and the pointing device 107 through the UI screen of the generation condition setting screen 3505. In the case where the user presses the next button 3507, the process proceeds to S3602.

In S3602, the poster creation condition designation component 201 and the target impression designation component 204 obtains settings corresponding to these components from the generation condition setting screen 3505. Specifically, the poster creation condition designation component 201 obtains designation of the poster size, the creation number, the image number, and the use application category by the user. The target impression designation component 204 obtains designation of the target impression by the user.

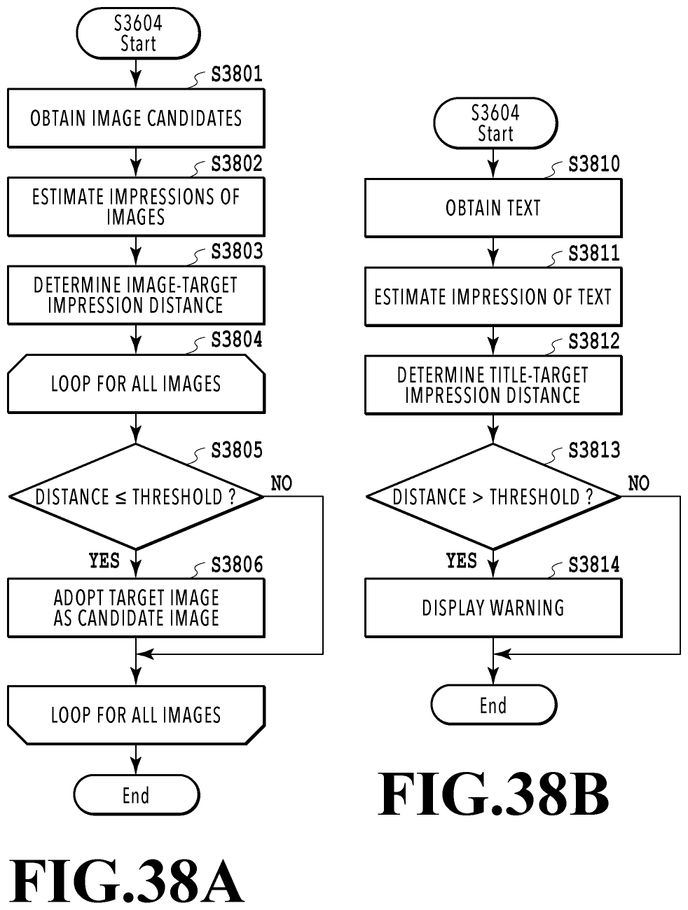

In S3603, the poster creation application displays the content setting screen 3501 on the display 105. The user inputs various settings with the keyboard 106 and the pointing device 107 through a UI screen of the content setting screen 3501. In the case where the user presses the image addition button 707 on the content setting screen 3501, the process proceeds to S3604, and a process illustrated in FIG. 38A is executed. Moreover, in the case where a title is inputted in the title box 702 in the content setting screen 3501, a process illustrated in FIG. 38B is executed in S3604.

In S3604, the content extraction component 3401 determines the images designatable in the image designation component 3402, based on the target impression obtained by the target impression designation component 204 in S3602 (process of FIG. 38A). Moreover, the content extraction component 3401 executes a later-described process relating to the designation of the title, based on the target impression obtained by the target impression designation component 204 in S3602 (process of FIG. 38B).

### <Content Extraction Process>

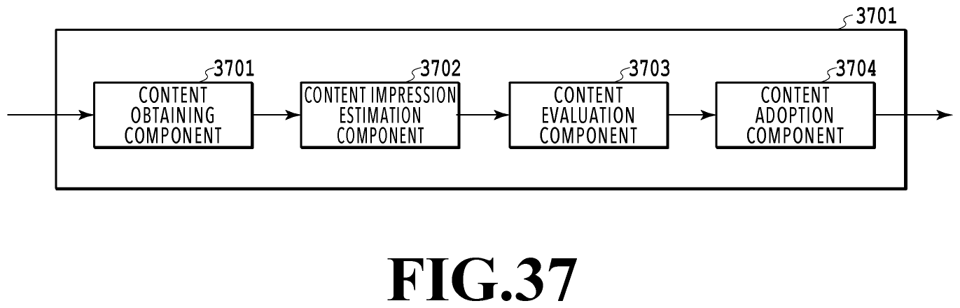

The content extraction process of S3604 and the content extraction component 3401 are explained in detail with reference to FIG. 37 and FIGS. 38A and 38B. FIG. 37 is an example of a software block diagram explaining the content extraction component 3401 in detail. The content extraction component 3401 includes a content obtaining component 3701, a content impression estimation component 3702, a content evaluation component 3703, and a content adoption component 3704. FIGS. 38A and 38B are flowcharts explaining the process of S3604 in detail.

The process flow illustrated in FIG. 38A is executed in the case where the user designates an image on the image designation screen 801 (FIG. 8) to which the screen transitions in the case where the image addition button 707 of the content setting screen 3501 displayed in S3603 is pressed. Specifically, the process flow is executed in the case where the reference button 809 of the image file, the reference button 811 of the image folder, the reference button 813 of the materials in the application (part), or the reference button 815 of the external cooperation material is pressed. Moreover, the process flow is executed in the case where the OK button 818 is pressed in the state where the radio button 804 of the materials in the application (all) or the radio button 807 of the AI image generation is designated.

In S3801, based on the reference button pressed in the image designation screen 801 or the radio button designated in the image designation screen 801, the content obtaining component 3701 obtains the image data associated with the button. Specifically, in the case where the reference button 809 or 811 is pressed, the content obtaining component 3701 obtains the images saved in the HDD104 and owned by the user. Moreover, in the case where the reference button 813 is pressed or the case where the OK button 818 is pressed in the state where the radio button 804 is designated, the content obtaining component 3701 obtains the application material images saved in the HDD 104. Furthermore, in the case where the reference button 815 is pressed, the content obtaining component 3701 obtains the cooperation material image through a network or a server. Moreover, in the case where the OK button 818 is pressed in the state where the radio button 807 is designated, the content obtaining component 3701 obtains the AI generated images generated by the image generative AI. The image generative AI may be included in the present poster generation apparatus. Alternatively, the configuration may be such that the image generative AI is included in another information processing apparatus that can be accessed by the present poster generation apparatus, and the present poster generation apparatus obtains the AI generated images via a network.

In S3802, the content impression estimation component 3702 estimates the impression of each of the multiple pieces of image data obtained in S3801 by using the trained model generated by the content impression quantification process illustrated in FIG. 9A.

In S3803, the content evaluation component 3703 determines a distance between the target impression obtained in S3602 and the estimated impression of each image estimated in S3802.

In S3804, a repeated process of S3805 and S3806 is started with all of the images for which the distances are determined in S3803 set as targets.

In S3805, the content evaluation component 3703 determines whether the distance for each target image determined in S3803 is equal to or less than a predetermined threshold. In the case where the content evaluation component 3703 determines that the distance determined in S3803 is equal to or less than the predetermined threshold, the process transitions to S3806. In the case where the content evaluation component 3703 determines that the distance determined in S3803 is larger than the predetermined threshold, S3806 is skipped, and the processes of S3805 and S3806 are performed as a loop process with the next image set as the target.

In S3806, the content adoption component 3704 adopts the target image as the candidate image. In the case where the process of the present flowchart is started by pressing of any of the reference buttons 809, 811, 813, and 815, the adopted candidate image is displayed on a dialog screen for designation by the user. Note that, although a not-adopted image is assumed not to be displayed on the dialog screen for designation by the user in the present embodiment, the present disclosure is not limited to this. For example, the not-adopted images may be displayed on the dialog screen in an unselectable state. Alternatively, the configuration may be such that the not-adopted image is displayed on the dialog screen in a selectable state, and a warning screen indicating that the not-adopted image does not suit the designated target impression is displayed in the case where the not-adopted image is selected by the user. Meanwhile, in the case where the process of the present flowchart is started by the pressing of the OK button 818 in the state where the radio button 804 or 807 is designated, the adopted candidate image is handled as an image designated by the user, and the processes of S3605 and beyond in FIG. 36 are performed. In the case where the processes of S3805 and S3806 are completed for all images for which the distances are determined in S3803, the process of the present flowchart is terminated.

Next, the process flow illustrated in FIG. 38B is explained. The present processing flow is executed in the case where the title is inputted in the content setting screen 3501 displayed in S3603. Specifically, the present process flow is executed in a state where a region other than the title box 702 of the content setting screen 3501 is active after the input of the title into the title box 702 by the user.

In S3810, the content obtaining component 3701 obtains the character information inputted into the title box 702.

In S3811, the content impression estimation component 3702 estimates the impression of the character information obtained in S3810 by using the trained model generated by the content impression quantification process illustrated in FIG. 9B.

In S3812, the content evaluation component 3703 determines a distance between the target impression obtained in S3602 and the impression of the character information estimated in S3811.

In S3813, the content evaluation component 3703 determines whether a value of the distance determined in S3812 is larger than a predetermined threshold or not. In the case where the content evaluation component 3703 determines that the value of the distance determined in S3812 is larger than the predetermined threshold, the process transitions to S3814. If not, the present flowchart is terminated.

In S3814, the content adoption component 3704 displays a warning screen indicating that the character information inputted into the title box 702 does not suit the target impression. The contents of the content extraction process executed in S3604 of FIG. 36 have been described above. The description returns to FIG. 36.

In S3605, the image designation component 3402 and the text designation component 3403 obtain the contents corresponding to these components from the content setting screen 3501. Specifically, the image designation component 3402 receives designation of the image by the user in the dialog screen in which the images adopted by the process of FIG. 38A are displayed as the image candidates. The image obtaining component 211 obtains the designated image data. The text designation component 3403 obtains the character information that is inputted by the user in the process of FIG. 38B and for which the warning screen is not displayed. The following processes (S1505 to S1514) are the same as those in the first embodiment.

As explained above, in the case where the poster creation application of the fourth embodiment obtains the image group designated by the user, the poster creation application extracts the images suiting the target impression designated by the user from the image group in advance based on the target impression. This limits the images designatable by the user. Moreover, the poster creation application of the fourth embodiment determines whether the title inputted by the user suits the target impression designated by the user or not, and notifies the user. The user can thereby efficiently designate the contents suiting the target impression. Accordingly, usability in the case where the user designates the contents to be arranged in the poster is improved. Moreover, a poster with an intended design can be obtained in fewer times of trial, and a poster suiting the target impression can be efficiently generated. Obtaining of a creation product with an intended design is facilitated also for a user who does not have a clear idea of contents desired to be used.

Although the preferable embodiments according to the present disclosure are explained above with reference to the attached drawings, the present disclosure is not limited to these examples. For example, in the second embodiment, the poster may be generated by selecting or extracting the contents as in the third or fourth embodiment and then combining the candidates of the contents with the components such as the skeleton, the color scheme, and the font. Moreover, the radar chart or the representation information such as the medium file or the sample image may be used as the object for designating the target impression also in the second to fourth embodiments. Moreover, the contents and the poster may be selected based on the similarity to the representation information designated by the user, in addition to the distance to the target impression, also in the second to fourth embodiments. Moreover, it is apparent that those skilled in the art can come up with various change examples or modification examples within the disclosed scope of the technical idea, and these change examples and modification examples are understood to also belong to the technical scope of the present disclosure as a matter of course.

According to the present disclosure, obtaining of a creation product with an intended design is facilitated also for a user who does not have a clear idea of contents desired to be used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-110259, filed Jul. 9, 2024, which is hereby incorporated by reference herein in its entirety.

What is claimed is:

1. An information processing apparatus configured to generate data of a creation product, the information processing apparatus comprising:
a reception unit configured receive designation of a target impression from a user, the target impression being an impression that is required to be eventually given by the creation product; and
a selection unit configured to select a content to be arranged in the creation product from a content group based on the target impression received by the reception unit, wherein
a first content selected by the selection unit in a case where the reception unit receives designation of a first target impression is different from a second content selected by the selection unit in a case where the reception unit receives designation of a second target impression different from the first target impression.

2. The information processing apparatus according to claim 1, wherein the selection unit selects the content to be arranged in the creation product based on the target impression received by the reception unit and an impression estimated from each of the contents included in the content group.

3. The information processing apparatus according to claim 2, wherein a value indicating a difference between the target impression received by the reception unit and the impression estimated from the content selected by the selection unit is smaller than a predetermined threshold.

4. The information processing apparatus according to claim 3, wherein the selection unit selects, as the first content, the content for which the value indicating the difference between the first target impression and the impression estimated from the first content is smaller than the threshold, from the content group in ascending order of the value indicating the difference, and selects, as the second content, the content for which the value indicating the difference between the second target impression and the impression estimated from the second content is smaller than the threshold, from the content group in ascending order of the value indicating the difference.

5. The information processing apparatus according to claim 1, further comprising a generation unit configured to generate the data of the creation product by using the content selected by the selection unit.

6. The information processing apparatus according to claim 5, wherein a value indicating a difference between an impression estimated from the data of the creation product generated by the generation unit and the target impression received by the reception unit is smaller than a predetermined threshold.

7. The information processing apparatus according to claim 1, further comprising a generation unit configured to generate a plurality of pieces of the data of the creation products in which at least one of the contents included in the content group is arranged, wherein
the selection unit selects the content to be arranged in the creation product by selecting the data of the creation product from among the plurality of pieces of data of the creation products generated by the generation unit, based on the target impression received by the reception unit.

8. The information processing apparatus according to claim 7, wherein the generation unit generates the plurality of pieces of data of the creation products by combining a component of the creation product and at least one of the contents included in the content group.

9. The information processing apparatus according to claim 1, wherein
the reception unit receives designation, by the user, of representation information representing the content, and
the selection unit selects the content to be arranged in the creation product from the content group, based on the target impression and the representation information received by the reception unit.

10. The information processing apparatus according to claim 9, wherein the selection unit selects the content from the content group based on similarity between each of the contents included in the content group and the representation information.

11. The information processing apparatus according to claim 1, wherein
the reception unit further receives designation, by the user, of the number of contents to be arranged in the creation product, and
the selection unit selects the contents as many as or more than the number received by the reception unit, from the content group.

12. The information processing apparatus according to claim 1, wherein
the reception unit further receives designation, by the user, of information for obtaining the content group, and
the information processing apparatus further comprises an obtaining unit configured obtain the content group based on the information for obtaining the content group received by the reception unit.

13. The information processing apparatus according to claim 1, wherein the reception unit receives the designation of the target impression by the user by receiving information representing an impression.

14. An information processing method of generating data of a creation product, the information processing method comprising:
receiving designation of a target impression from a user, the target impression being an impression that is required to be eventually given by the creation product; and
selecting a content to be arranged in the creation product from a content group based on the target impression received in the receiving, wherein
a first content selected in the selecting in a case where designation of a first target impression is received in the receiving is different from a second content selected in the selecting in a case where designation of a second target impression different from the first target impression is received in the receiving.

15. A non-transitory computer readable storage medium storing a program which causes a computer to execute an information processing method of generating data of a creation product, the information processing method comprising:
receiving designation of a target impression from a user, the target impression being an impression that is required to be eventually given by the creation product; and
selecting a content to be arranged in the creation product from a content group based on the target impression received in the receiving, wherein
a first content selected in the selecting in a case where designation of a first target impression is received in the receiving is different from a second content selected in the selecting in a case where designation of a second target impression different from the first target impression is received in the receiving.

16. The storage medium according to claim 15, wherein, in the selecting, the content to be arranged in the creation product is selected based on the target impression received in the receiving and an impression estimated from each of the contents included in the content group.

17. The storage medium according to claim 16, wherein a value indicating a difference between the target impression received in the receiving and the impression estimated from the content selected in the selecting is smaller than a predetermined threshold.

18. The storage medium according to claim 17, wherein, in the selecting, the content for which the value indicating the difference between the first target impression and the impression estimated from the first content is smaller than the threshold is selected as the first content from the content group in ascending order of the value indicating the difference, and the content for which the value indicating the difference between the second target impression and the impression estimated from the second content is smaller than the threshold is selected as the second content from the content group in ascending order of the value indicating the difference.

19. The storage medium according to claim 15, wherein the information processing method further comprises generating the data of the creation product by using the content selected in the selecting.

20. The storage medium according to claim 19, wherein a value indicating a difference between an impression estimated from the data of the creation product generated in the generating and the target impression received in the receiving is smaller than a predetermined threshold.
